(19) United States
(12) Patent Application Publication
(10) Pub. No.: US 2026/0245196 A1
(43) Pub. Date: Aug. 20, 2026

(54) MEASUREMENT REPETITION BETWEEN STRUCTURALLY SIMILAR IMAGES

(71) Applicant: Applied Materials, Inc., Santa Clara, CA (US)

(72) Inventors: Abhinav Kumar, Milpitas, CA (US); Ioannis Papakis, San Jose, CA (US); Chukka Srinivas, San Jose, CA (US); Adrienne Melissa Martin Bergh, Los Gatos, CA (US)

(21) Appl. No.: 18/847,183

(22) PCT Filed: Sep. 13, 2023
(86) PCT No.: PCT/GR2023/000048

§ 371 Date: Sep. 13, 2024

(51) Int. Cl. G06T 7/00; G06T 3/18; G06T 7/11; G06T 7/33; G06T 7/73

(52) U.S. Cl. CPC G06T 7/001; G06T 3/18; G06T 7/11; G06T 7/337; G06T 7/74; G06T 2207/20081; G06T 2207/30148

(57) ABSTRACT

A method includes training a machine learning model using a training dataset including historical image data of a structure, the historical image data including a plurality of images of the structure. The training includes labeling regions of a source image of the plurality of images to create a source mask for the source image and providing as training input to the machine learning model the source image and a target image of the plurality of images. The training further includes receiving as output from the machine learning model a deformation field between the source image and the target image. The training further includes applying the deformation field to the source mask to create a warped source mask. The training further includes computing a loss associated with the warped source mask. The training further includes updating weights of the machine learning model based on the loss.

### RELATED APPLICATIONS

This application claims the benefit of International Patent Application No. PCT/GR23/00048, filed Sep. 13, 2023, the entire content of which is hereby incorporated by reference.

### TECHNICAL FIELD

The present disclosure relates to image registration. More particularly, the present disclosure relates to deformable image registration.

### BACKGROUND

Manufacturing equipment is used to produce products. For example, substrate processing equipment is used to produce substrates (e.g., wafers, semiconductors). Manufactured substrates have properties that can be measured. Products are to be produced with particular structures, suited for a target application. Measurements can be taken of structurally similar products. Measurements can be taken of different images (e.g., of manufactured substrates) that share similar structures.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or dany scope of the claims. Its sole purpose is to present some concepts of the disclosure in a simplified form as a prelude to the more detailed description that is presented later.

An aspect of the disclosure includes a method including training a machine learning model using a training dataset including historical image data of a structure, the historical image data including a plurality of images of the structure, where the training includes labeling regions of a source image of the plurality of images to create a source mask for the source image. The training further includes providing as training input to the machine learning model the source image and a target image of the plurality of images. The training further includes receiving as output from the machine learning model a deformation field between the source image and the target image. The training further includes applying the deformation field to the source mask to create a warped source mask. The training further includes computing a loss associated with the warped source mask. The training further includes updating weights of the machine learning model based on the loss.

A further aspect of the disclosure includes a non-transitory computer-readable storage medium comprising instructions that, when executed by a processing device operatively coupled to a memory, performs operations. The operations include receiving an input comprising a template image and a test image, where the template image comprises labels (e.g., manually placed) for a first location and a second location associated with a first measurement of the template image. The operations further include providing the template image and the test image as input to a trained machine learning model, where the trained machine learning model outputs a deformation field based on non-rigid registration of the template image to the test image. The operations further include determining, based on application of the deformation field to the template image, a third location and a fourth location on the test image that correspond to the first location and the second location, respectively, on the template image, where the third location and the fourth location are usable to determine the first measurement of the test image.

A further aspect of the disclosure includes a system including a memory and a processing device coupled to the memory. The processing device is to train a machine learning model using a training dataset including historical image data of a structure, the historical image data including a plurality of images of the structure, where the training includes labeling regions of a source image of the plurality of images to create a source mask for the source image. The training further includes providing as training input to the machine learning model the source image and a target image of the plurality of images. The training further includes receiving as output from the machine learning model a deformation field between the source image and the target image. The training further includes applying the deformation field to the source mask to create a warped source mask. The training further includes computing a loss associated with the warped source mask. The training further includes updating weights of the machine learning model based on the loss.

### BRIEF DESCRIPTION OF THE DRAWINGS

The present disclosure is illustrated by way of example, and not by way of limitation in the figures of the accompanying drawings.

FIG. 1 is a block diagram illustrating an example system architecture, according to some embodiments.

FIG. 2 illustrates a data set generator associated with measurement repetition between structurally similar images, according to some embodiments.

FIG. 3 is a block diagram illustrating determining predictive data associated with measurement repetition between structurally similar images, according to some embodiments.

FIG. 4A is a block diagram illustrating training of a machine learning model to perform image registration and/or determination of measurement locations, according to some embodiments.

FIG. 4B is a block diagram illustrating using a machine learning model to perform image registration between an input source and target image, according to some embodiments.

FIGS. 5A-C are example of exact point placement, according to some embodiments.

FIGS. 6A-B are an examples of exact point placement using a reference point, according to some embodiments.

FIGS. 7A-C are flow diagrams of methods associated with measurement repetition between structurally similar images, according to some embodiments.

FIG. 8 is a block diagram illustrating a computer system, according to some embodiments.

### DETAILED DESCRIPTION

Described herein are technologies directed to measurement repetition between structurally similar images (e.g., using deformable image registration and/or exact point placement). Also described herein are technologies directed to training and use of one or more machine learning models to automate selection of points to make measurements of images of similar structures. In embodiments, measurement points may be selected in a template image, and the template image with the selected images may be provided to a trained machine learning model along with a test image to be measured. The trained machine learning model may output points on the test image to be measured. The template image and the test image may be of a same type of structure (e.g., a same structure of a semiconductor device), but may be of different instances of that same type of structure in embodiments. Accordingly, the specific locations to be measured in the different images may not be the same. Historically this has meant that a technician manually marks the locations to be measured in each image. Embodiments enable locations to be measured to be marked in a single image, and the locations to be measured in one or more additional images of a same type of structure to be measured automatically without manual marking of the locations in the additional images. The specific locations that are automatically selected in the additional images may not correspond to the same coordinates (e.g., same x, y and/or z coordinates) as the coordinates of the points to be measured in the template image. In embodiments, the test image is automatically measured using the automatically marked locations. Embodiments increase the speed at which measurements of critical dimensions of devices (e.g., of semiconductor devices) and/or of layers of devices can be measured and reduce an amount of time that technicians spend making such measurements.

Embodiments also cover techniques for training a machine learning model to receive a marked template image and a test image, and to output locations on the test image to be measured.

In many applications in the semiconductor industry, many different images that have the same structure may be measured.

Manufacturing equipment is used to produce products. For example, substrate processing equipment is used to produce substrates (e.g., wafers, semiconductors). Manufactured substrates have properties (e.g., property data) that are measured. Various applications benefit from the measurement of different images (e.g., of manufactured substrates) that share similar structures. Frequently, multiple similar-looking images may be measured to identify and analyze specific attributes such as critical dimensions (CDs), heights of features, depth of holes, etc. of different instances of a same structure (e.g., of a same region or area of a semiconductor device). For example, in the context of a cross-section image of a device, an engineer may measure the depth of a hole or trench to determine whether the device being manufactured complies with specifications. Subsequently, the same attribute, e.g., the depth, might be measured in similar holes or trenches of a same device in other images. The other images may be of a different instance of a same device on a same substrate (e.g., different devices on a same wafer) or on a different substrate (e.g., different devices on different wafers). For example, in a cross-sectional image an engineer might be interested in measuring the height of a hole or a width of the hole at a certain height. That height or width may be measured again for multiple other holes for a same type of structure. To achieve such measurements in embodiments, automated image registration and exact point placement are determined, and automated measurements are generated based on the automated exact point placement.

In image registration, each pixel of a first image may be transferred to a second image so that the image structure and coherence is maintained based on the similarity of the images. Rigid registration may be the simplest way to transfer each pixel and includes rotation and translation of the first image. Affine registration allows for shearing and scaling of the first image. Non-rigid registration is capable of aligning images with local deformations, in which each pixel is transferred independently of the other pixels preserving more complex structural deformities and variability.

Performing measurements across numerous images presents challenges that generally result in manual measurements being performed in many images. For example, due to the similarity yet non-identical nature of the structures, and a goal for accurate and consistent results, measurement of the same points cannot generally be made across different images of a same structure. Measurement consistency and accuracy is a goal to ensure reliable analysis and decision-making in semiconductor manufacturing processes. However, manually measuring each instance of a particular attribute in different images is time-consuming, labor-intensive, and prone to error.

Existing solutions to address this issue often involve manual measurement techniques, which rely on human operators to visually identify and measure the target attribute or structure in each image. This manual approach not only increases the risk of inconsistencies and inaccuracies across images, but also significantly limits the efficiency and throughput of the measurement process. Moreover, the manual nature of these techniques makes them susceptible to operator fatigue, variations in measurement techniques, and limitations in human perception.

Aspects and implementations of the present disclosure address these and other shortcomings of the existing technology by performing a method for measurement repetition between structurally similar images, such as by image registration and exact point placement across images for repeatable measurement, overcoming the limitations of existing measurement techniques.

In embodiments, a processing device trains a machine learning model using a training dataset including historical image data of a structure The historical image data includes a plurality of images of the structure. The training comprises labeling regions of a source image of the plurality of images to create a source mask for the source image. The training further includes providing as training input to the machine learning model the source image and a target image of the plurality of images. The training further includes receiving as output from the machine learning model a deformation field (also referred to as a registration flow) between the source image and the target image. The training further includes applying the deformation field to the source mask to create a warped source mask. The training further includes computing a loss associated with the warped source mask. The training further includes updating weights of the machine learning model based on the loss. In some embodiments, the machine learning model may include at least one of a convolutional neural network (CNN) or an encoder-decoder network.

In some embodiments, the training may further include applying the deformation field to the source image to create a warped source image. The training may further include computing one or more similarity metrics losses for the target image and the warped source image. The training may further include updating weights of the machine learning model based on the one or more similarity metrics losses. In some embodiments, the loss associated with the warped source mask may include a structural integrity loss, and the one or more similarity metrics losses may include a structural similarity index (SSI) loss and a Pearson correlation coefficient (PCC) loss.

In some embodiments, the method may further include receiving an input comprising a template image and a test image, where the template image comprises labels for a first location and a second location associated with a first measurement of the template image. The method may further include providing the template image and the test image as input to the trained machine learning model, where the trained machine learning model outputs a deformation field based on non-rigid registration of the template image to the test image. The method may further include receiving, from the trained machine learning model, an output including a third location and a fourth location on the test image, the third location and the fourth location are usable to determine the first measurement of the test image. In some embodiments, the third location of the test image may correspond to the first location of the template image after non-rigid registration of the test image to the template image.

In some embodiments, the first and second locations on the template image may be positioned at a vertical distance from a first reference point and the third and fourth locations on the test image may be positioned at the vertical distance from a second reference point.

In some embodiments, the method may further include extracting a template signal along a first line intersecting the first location and the second location on the template image. The method may further include extracting a test signal along a second line intersecting the third location and the fourth location on the test image. The method may further include adjusting at least one of the third location or the fourth location using a dynamic time warping (DTW) transformation of the test signal to the template signal. In some embodiments, the template signal and the test signal each include an average of pixel values of pixels along the first line and the second line, respectively.

In some embodiments, the method may further include identifying a template signal local maximum, where the template signal local maximum is a closest local maximum to a point on the template signal corresponding to the first location on the template image to a point on the template signal corresponding to the first location on the template image. In some embodiments, the method may further include identifying a template signal local minimum, wherein the template signal local minimum is a closest local minimum to a point on the template signal corresponding to the first location on the template image.

The method may further include identifying a test signal local maximum, where the test signal local maximum is a closest local maximum to a point on the test signal corresponding to the third location on the test image. The method may further include identifying a test signal local minimum, where the test signal local minimum is a closest local minimum to a point on the test signal corresponding to the third location on the test image.

The method may further include calculating a first ratio representing a relationship between a proximity of the point on the template signal to the template signal maximum and a proximity of the point on the template signal to the template signal minimum. The method may further include adjusting the third location so that a second ratio representing a relationship between a proximity of the point on the test signal to the test signal maximum and a proximity of the point on the test signal to the test signal minimum is approximately equal to the first ratio.

Aspects of the present disclosure result in technological advantages. Aspects of the present disclosure avoid the time-consuming, labor intensive, and error prone process of manually measuring each instance of a particular attribute of a structure (e.g., a same critical dimension for different instances of a same device) in different images. Aspects of the present disclosure do not rely on human operators to visually identify and measure a desire attribute in each image. Aspects of the present disclosure decrease the risk of inconsistencies and inaccuracies of critical dimension (CD) measurements and also improve the efficiency and throughput of the measurement process. Aspects of the present disclosure are not susceptible to operator fatigue, variations in measurement techniques, or limitations in human perception. Aspects of the present disclosure may avoid delays in manufacturing, and corresponding loss of throughput. Aspects of the present disclosure allow for more accurate and consistent measurement of similar structures in different images (e.g., of manufactured substrates).

Although some embodiments of the present disclosure describe measurement repetition between structurally similar images associated with manufacturing systems (e.g., substrate processing equipment, manufacturing equipment, etc.) the present disclosure can be used for measurement repetition between structurally similar images associated with other fields (e.g., medical imaging, remote sensing, computer vision and robotics, geographical information systems, industrial inspection and quality control, astronomy and astrophysics, security and surveillance, forensics, agricultural and environmental monitoring, etc.).

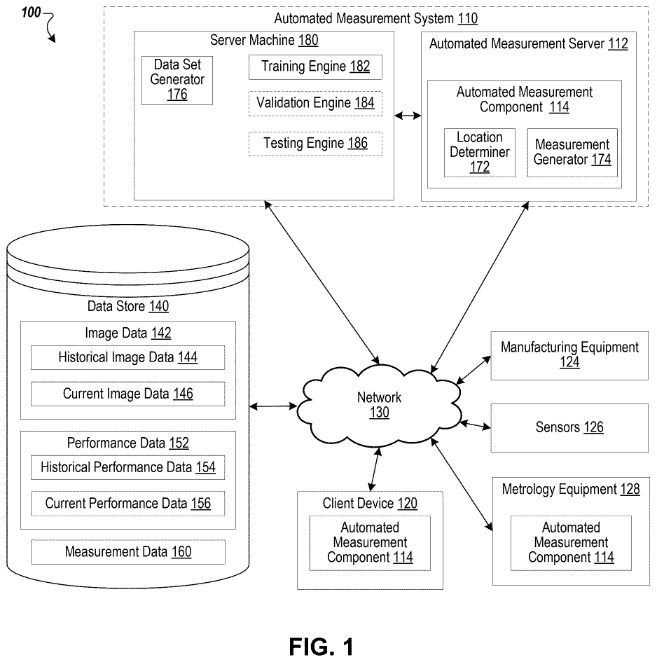

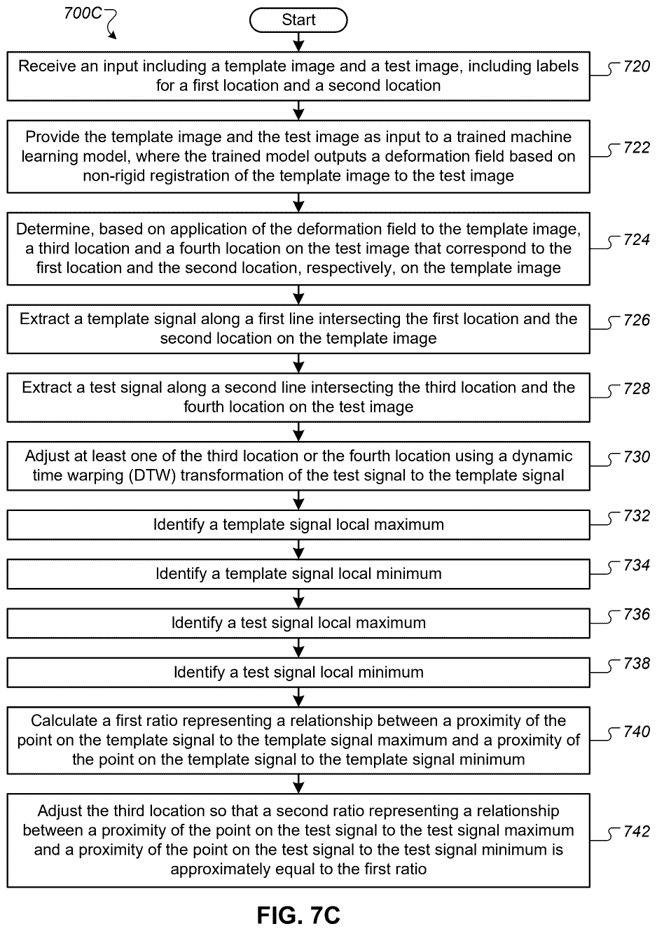

FIG. 1 is a block diagram illustrating an exemplary system 100 (exemplary system architecture), according to certain embodiments. The system 100 (e.g., via automated measurement component 114) can perform one or more of the methods described herein (e.g., methods 700A-C of FIGS. 7A-C). The system 100 may include a client device 120, manufacturing equipment 124, sensors 126, metrology equipment 128, an automated measurement server 112, and/or a data store 140. In some embodiments, the automated measurement server 112 is part of an automated measurement system 110. In some embodiments, the automated measurement system 110 further includes server machine 180.

In some embodiments, one or more of the client device 120, manufacturing equipment 124, sensors 126, metrology equipment 128, automated measurement server 112, data store 140, and/or server machine 180 are coupled to each other via a network 130. In at least one embodiment, automated measurement system 110 trains one or more machine learning models to perform measurement repetition between structurally similar images. In at least one embodiment, automated measurement system 110 implements one or more trained machine learning models (e.g., in location determiner 172) to determine locations in images from which to take measurements. In embodiments, images to be measured may be generated during and/or after substrate manufacturing.

In some embodiments, network 130 is a public network that provides client device 120 with access to the automated measurement server 112, data store 140, and/or other publicly available computing devices. In some embodiments, network 130 is a private network that provides client device 120 access to manufacturing equipment 124, sensors 126, metrology equipment 128, data store 140, automated measurement server 112 and/or other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the client device 120 includes a computing device such as Personal Computers (PCs), laptops, mobile phones, smart phones, tablet computers, netbook computers, etc. In some embodiments, the client device 120 includes a local automated measurement component 114, which may correspond to automated measurement component 114 of automated measurement server 112. Client device 120 includes an operating system that allows users to one or more of consolidate, generate, view, and/or edit data (e.g., image data), provide directives to the automated measurement system 110 (e.g., machine learning processing system), provide information to automated measurement system 112 (e.g., including images to be measured, a template image with selected measurement points to be used to determine measurement points of other target images), etc.

Manufacturing equipment 124 can produce products, such as substrates, wafers, semiconductors, electronic devices, etc., following execution of one or more recipes and/or processes to substrates over a period of time. Manufacturing equipment 124 can include one or more sensors configured to capture data (e.g., property data such as image data) for a substrate before, during and/or after a substrate processing operation. For example, the one or more sensors can be configured to capture image data and/or images of substrates (e.g., cross-sectional images, scanning electron microscopy (SEM) images, optical images, atomic force microscopy images, overlay images, infrared images, reflectance images, transmittance images, etc.), spectral data, non-spectral data, etc. for a portion of a substrate before, during, or after a substrate processing operation.

Manufacturing equipment 124 can perform a process on a substrate (e.g., a wafer, etc.) at a processing chamber. Examples of substrate processes include a deposition process to deposit one or more layers of film on a surface of the substrate, an etch process to form a pattern on the surface of the substrate, etc. Manufacturing equipment 124 can perform each process according to a process recipe. A process recipe defines a particular set of operations to be performed on the substrate during the process and can include one or more settings associated with each operation. One or more processes performed on a substrate form structures on the substrate. The structures may have one or more regions that may have one or more critical dimensions (e.g., that can be labeled). For example, an image of a structure may have labels designating locations of a coating, a gate, a drain, a mask, and/or other structures.

In some embodiments, manufacturing equipment 124 includes sensors 126 that are configured to generate data (e.g., image data) associated with a substrate processed at manufacturing system 100. For example, a manufacturing equipment 124 can include one or more sensors configured to generate image data (e.g., scanning electron microscopy (SEM) images, optical images, atomic force microscopy images, overlay images, infrared images, reflectance images, transmittance images, etc.) associated with the substrate and/or structures of the substrate before, during, and/or after a process (e.g., a deposition process).

Metrology equipment 128 can provide metrology data (e.g., image data) associated with substrates processed by manufacturing equipment 124. The metrology data can include one or more images of a processed substrate, such as cross-sectional images, top down images, SEM images, optical images, atomic force microscopy images, overlay images, infrared images, reflectance images, transmittance images, and so on. In some embodiments, the metrology data can further include a value of one or more types of surface profile property data (e.g., a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology data can be generated using, for example, reflectometry techniques, ellipsometry techniques, transmission electron microscopy (TEM) techniques, and so forth. In some embodiments, metrology data includes cross-sectional images, scanning electron microscopy (SEM) images, optical images, atomic force microscopy images, overlay images, infrared images, reflectance images, transmittance images, etc. In some embodiments, metrology equipment 128 includes an instance of automated measurement component 114 and can generate automated measurements of generated images during and/or after generation of the images.

In some embodiments, the automated measurement server 112 and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The automated measurement server 112 may include an automated measurement component 114, which may additionally or alternatively be included in client device 120 and/or metrology equipment 128. In some embodiments, the automated measurement component 114 identifies image data 142 (e.g., historical image data 144 and/or current image data 146) to be processed. In some embodiments, automated measurement component 114 automatically determines locations in image data 142 to be measured, and automatically generates measurements based on such determined locations. In some embodiments, the automated measurement component 114 uses one or more trained machine learning models to determine the locations to be measured. In some embodiments, location determiner 172 is a trained machine learning model that is trained to receive a template image with selected measurement points and one or more target images, and to output locations on the one or more target images to be measured. In some embodiments, location determiner 172 is trained using historical image data 144. In some embodiments, nodes of location determiner 172 are updated using backpropagation. For example, a warped source image and warped source mask may be compared with target image to determine differences therebetween. These differences may then be used to update nodes of location determiner 172.

In some embodiments, the location determiner 172 generates indications of locations to be measured. In embodiments, location determiner is trained using supervised or semi-supervised machine learning (e.g., a supervised data set, historical image data 144 labeled with locations to be measured, etc.). In some embodiments, a first subset of the historical image data 144 is labeled data and a second subset of the of the historical image data 144 is unlabeled. In some embodiments, a data set generator 176 of server machine 180 generates a training dataset for training location determiner 172.

In some embodiments, the manufacturing equipment 124 (e.g., deposition chamber, cluster tool, wafer backgrind systems, wafer saw equipment, die attach machines, wirebonders, die overcoat systems, molding equipment, hermetic sealing equipment, metal can welders, deflash/trim/form/singulation (DTFS) machines, branding equipment, lead finish equipment, and/or the like) is part of a substrate processing system (e.g., integrated processing system). The manufacturing equipment 124 includes one or more of a controller, an enclosure system (e.g., substrate carrier, front opening unified pod (FOUP), autoteach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers, a robot arm (e.g., disposed in the transfer chamber, disposed in the front interface, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device may be disposed in the factory interface to align substrates. The load lock and the processing chambers may mount to the transfer chamber, and a robot arm disposed in the transfer chamber is to transfer content (e.g., substrates, process kit rings, carriers, validation wafer, etc.) between the load lock, the processing chambers, and the transfer chamber. In some embodiments, the manufacturing equipment 124 includes components of substrate processing systems. In some embodiments, the image data 142 of a substrate depicts results from the substrate undergoing one or more processes performed by components of the manufacturing equipment 124 (e.g., deposition, etching, heating, cooling, transferring, processing, flowing, etc.).

In some embodiments, the sensors 126 provide image data 142 (e.g., image data such as historical image data and current image data) of a substrate processed by manufacturing equipment 124 and/or one or more structures of the substrate (e.g., transistors, interconnects, gates, contacts, memory cells, etc.).

In some embodiments, the sensors 126 include one or more of a metrology tool such as optical and imaging systems, imaging stations, and/or the like. In some embodiments, the sensors 126 include one or more of a metrology tool such as ellipsometers (used to determine the properties and surfaces of thin films by measuring material characteristics such as layer thickness, optical constants, surface roughness, composition, and optical anisotropy), ion mills (used to prepare heterogeneous bulk materials when wide areas of material are to be uniformly thin), capacitance versus voltage (C-V) systems (used to measure the C-V and capacitance versus time (C-t) characteristics of semiconductor devices), interferometers (used to measure distances in terms of wavelength, and to determine wavelengths of particular light sources), source measure units (SME) magnetometers, profilometers, wafer probers (used to test a semiconductor wafer before it is separated into individual dies or chips), critical-dimension scanning electron microscope (CD-SEM, used to ensure the stability of the manufacturing process by measuring critical dimensions of substrates), reflectometers (used to measure the reflectivity and radiance from a surface), resistance probes (used to measure the resistivity of thin-films), resistance high-energy electron diffraction (RHEED) system (used to measure or monitor crystal structure or crystal orientation of epitaxial thin-films of silicon or other materials), X-ray diffractometers (used to unambiguously determine crystal structure, crystal orientation, film thickness and residual stress in silicon wafers, epitaxial films, or other substrates), and/or the like.

In some embodiments, the image data 142 is used for assessment of equipment health and/or product health (e.g., product quality). For example, image data 142 may be image data used to take measurements of products (e.g., manufactured wafers). In some embodiments, the image data 142 is received over a period of time.

In some embodiments, sensors 126 and/or metrology equipment 128 provide image data 142, which may include one or more of scanning electron microscope (SEM) images, energy dispersive x-ray (EDX) images, spatial location data, chip layer data, chip layout data, edge data, grey level data, signal to noise data, spacing data, optical image data, and/or the like.

In some embodiments, image data 142 includes data that describes the visual attributes of an image that may be organized in a matrix or multidimensional array. In some embodiments, image data allows for digital representation, processing, and analysis pixel-level information of an image. In some embodiments, measurement data is to be generated from image data 142. Measurement data may relate to measurements of a substrate, such as critical dimension. In some embodiments, measurements of image data 142 includes size attribute data (e.g., data describing the size of attributes of a substrate). In some embodiments, measurements of image data 142 includes dimensional attribute data (e.g., data that describes the dimensions of attributes of a substrate). In some embodiments, image data 142 includes SEM images (e.g., images captured by a scanning electron microscope using a focused beam of electrons to scan a surface of a substrate to create a high-resolution image). In some embodiments, image data 142 includes EDX images (e.g., images generated from data that is collected using an x-ray technique to identify the elemental composition of materials). In some embodiments, measurements of image data 142 includes defect distribution data (e.g., data that describes the distribution, such as spatial, temporal, etc., of defects on a substrate). In some embodiments, measurements of image data 142 includes spatial location data (e.g., data that describes the spatial location of attributes, defects, elements, etc. of a substrate). In some embodiments, image data 142 includes grey level data (e.g., data that describes the brightness of a pixel of an image of a substrate) and signal to noise data (e.g., data that describes the signal to noise ratio of a substrate measure with, for example, spectrometry equipment).

In some embodiments, the image data 142 (e.g., historical image data 144, current image data 146, etc.) is processed (e.g., by the client device 120 and/or by the automated measurement server 112). In some embodiments, processing of the image data 142 includes generating features (e.g., measurements, critical dimensions, etc.). In some embodiments, the features are a measurement or a pattern in the image data 142 (e.g., slope, width, height, peak, etc.) or a combination of values from the image data 142.

In some embodiments, metrology equipment 128 can be included as part of the manufacturing equipment 124. For example, metrology equipment 128 can be included inside of or coupled to a processing chamber and configured to generate metrology data such as image data 142 of a substrate before, during, and/or after a process (e.g., a deposition process, an etch process, etc.) while the substrate remains in the processing chamber. In some instances, metrology equipment 128 can be referred to as in-situ metrology equipment. In another example, metrology equipment 128 can be coupled to another station of manufacturing equipment 124. For example, metrology equipment can be coupled to a transfer chamber, a load lock, or a factory interface.

In some embodiments, sensors 126 can be included as part of the manufacturing equipment 124. For example, sensors 126 can be included inside of or coupled to a processing chamber and configured to generate sensor data of a substrate before, during, and/or after a process (e.g., a deposition process, an etch process, etc.) while the substrate remains in the processing chamber. In some instances, sensors 126 can be referred to as in-situ sensors. In another example, sensors 126 can be coupled to another station of manufacturing equipment 124. For example, sensors can be coupled to a transfer chamber, a load lock, or a factory interface.

In some embodiments, the metrology equipment 128 (e.g., ellipsometry equipment, imaging equipment, spectroscopy equipment, etc.) is used to determine metrology data (e.g., image data, inspection data, spectroscopy data, ellipsometry data, material compositional, optical, or structural data, etc.) corresponding to substrates produced by the manufacturing equipment 124 (e.g., substrate processing equipment). In some examples, after the manufacturing equipment 124 processes substrates, the metrology equipment 128 is used to inspect portions (e.g., structures, regions, layers, etc.) of the substrates. In some embodiments, the metrology equipment 128 performs scanning acoustic microscopy (SAM), ultrasonic inspection, x-ray inspection, and/or computed tomography (CT) inspection.

In some examples, after the manufacturing equipment 124 deposits one or more layers on a substrate, the metrology equipment 128 is used to determine quality of the processed substrate (e.g., dimensions of features and/or structures, uniformity of features and/or structures, and/or the like). In some embodiments, the metrology equipment 128 includes an imaging device (e.g., SAM equipment, ultrasonic equipment, x-ray equipment, CT equipment, and/or the like). In some embodiments, image data 142 includes sensor data from sensors 126 and/or metrology data from metrology equipment 128 located in-situ (inside the processing chamber).

In some embodiments, performance data 152 is measured by sensors 126 and/or metrology equipment 128 and may be associated with measurement consistency and accuracy for manufactured substrates.

In some embodiments, measurement data 160 may be generated for one or more images of image data 142. The measurement data may be measurements of structures, critical dimensions, and/or other properties of features that appear in image data 142. In embodiments, measurement data 160 may be automatically generated for one or more target images by automated measurement component 114 responsive to automated measurement component 114 receiving and processing a labeled template image and the one or more target images. In some embodiments, measurement data 160 may be included in image data 142 (e.g., by annotating image data 142).

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of image data 142, performance data 152, and/or measurement data 160.

Measurement consistency and accuracy is beneficial to ensure reliable analysis and decision-making in semiconductor manufacturing processes. Taking manual measurements of each instance of a particular attribute in different images is time-consuming, labor-intensive, and prone to error. By providing image data 142 to automated measurement component 114 and receiving automated measurement data 160 from the automated measurement component 114, system 100 has the technical advantage of avoiding the time-consuming, labor-intensive, and error prone process of manually measuring each instance of a particular attribute in different images.

In some embodiments, automated measurement system 110 includes server machine 180. Server machine 180 may include a data set generator 176 that is capable of generating data sets (e.g., a set of data inputs and a set of target outputs) to train, validate, and/or test one or more machine learning model(s) (e.g., such as location determiner 172). The data set generator 176 has functions of data gathering, compilation, reduction, and/or partitioning to put the data in a form for machine learning. In some embodiments (e.g., for small datasets), partitioning (e.g., explicit partitioning) for post-training validation is not used. Repeated cross-validation (e.g., 5-fold cross-validation, leave-one-out-cross-validation) may be used during training where a given dataset is in-effect repeatedly partitioned into different training and validation sets during training.

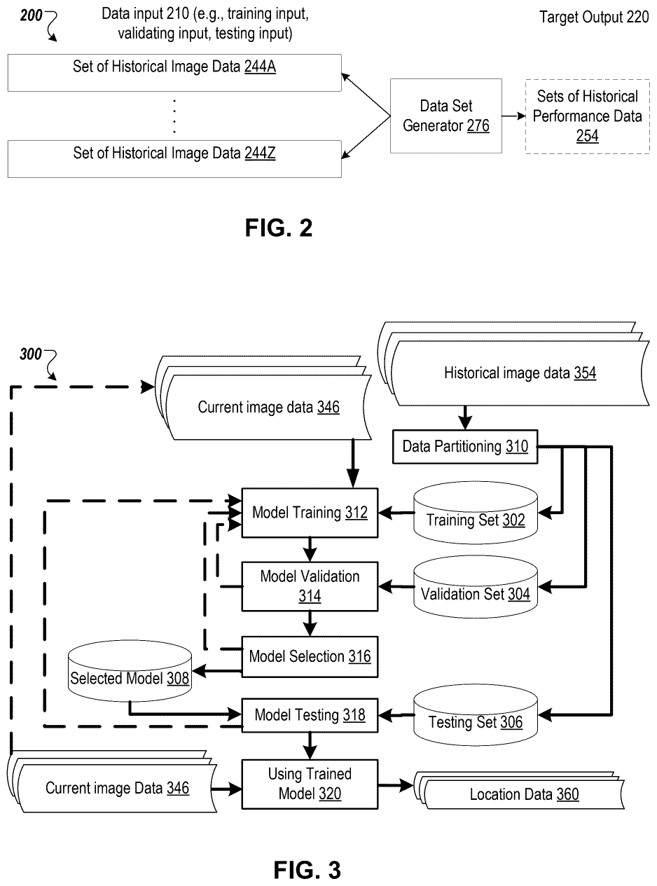

In some embodiments, the data set generator 176 may explicitly partition the historical data (e.g., historical image data 144) into a training set (e.g., sixty percent of the historical data), a validating set (e.g., twenty percent of the historical data), and a testing set (e.g., twenty percent of the historical data). Some operations of data set generator 176 are described in detail below with respect to FIG. 2 according to some embodiments.

Server machine 180 includes a training engine 182, a validation engine 184, and/or a testing engine 186. In some embodiments, an engine (e.g., training engine 182, a validation engine 184, and a testing engine 186) refers to hardware (e.g., circuitry, dedicated logic, programmable logic, microcode, processing device, etc.), software (such as instructions run on a processing device, a general-purpose computer system, or a dedicated machine), firmware, microcode, or a combination thereof. The training engine 182 is capable of training a machine learning model (e.g., of location determiner 172) using one or more sets of features associated with the training set from data set generator 176. In some embodiments, the training engine 182 generates multiple trained machine learning models, where each trained machine learning model (e.g., of location determiner 172) corresponds to a distinct set of parameters of a training set (e.g., image data 142). In some embodiments, multiple models are trained with distinct targets. For example, different models may be trained for automatically selecting locations to be measured for different structures and/or different devices. Embodiments of training are described in greater detail with respect to FIGS. 2-4A.

In some embodiments, performance data 152 may be associated with measurement consistency and accuracy for manufactured substrates (e.g., for measurement repetition between structurally similar images). For example, performance data 152 may be indicative of a critical dimension measurement. In some embodiments, at least a portion of the performance data 152 is associated with a quality of measurements of substrates produced by the manufacturing equipment 124. Performance data 152 may be indicative of whether a measurement is properly and/or accurately taken. For example, two images may be structurally similar but are not identical. Performance data 152 may indicate that a measurement taken of a first image is similarly taken of a second structurally similar but not identical image (e.g., by image-to-image registration where each pixel is transferred from a first image to a second image such that the structure and coherence of the images is maintained).

In some embodiments, at least a portion of the performance data 152 is based on metrology data (e.g., image data) from the metrology equipment 128 (e.g., historical performance data 154 includes metrology data indicating properly processed substrates, image data of substrates, images of structures and/or features of manufactured substrates, etc.) or sensors 126 (e.g., historical performance data 154 includes sensor data indicating properly processed substrates, image data of substrates, images of structures and/or features of manufactured substrates, etc.). In some embodiments, at least a portion of the performance data 152 is based on inspection of the substrates (e.g., current performance data 156 based on actual inspection). In some embodiments, performance data 152 includes user input (e.g., via client device 120) indicating a quality of the substrates. In some embodiments, the performance data 152 includes an indication of an absolute value (e.g., inspection data of the substrates indicates missing the threshold data by a calculated value, drift value misses the threshold drift value by a calculated value) or a relative value (e.g., inspection data of the measurement data 160 indicates missing the threshold data by 5%, drift value misses threshold drift value by 5%). In some embodiments, the performance data 152 is indicative of meeting a threshold amount of error (e.g., at most 5% error in measurement data following a repeating a measurement, at most 5% error in production, etc.).

In some embodiments, image data 142 may be associated with a target image and/or a test image. In some embodiments, measurement data 160 may be associated with a deformation field (e.g., generated by location determiner 172). In some embodiments, measurement data 160 may be associated with applying a deformation field to a source mask to create a warped source mask.

In some embodiments, training the machine learning model may include computing a structural integrity loss (e.g., a structural similarity index (SSI) loss and/or a Pearson correlation coefficient (PCC) loss) for the warped source mask. In some embodiments, training the machine learning model may include applying the deformation field to a source image to create a warped source image and computing one or more similarity metrics losses for a target image and the warped source image. For example, measurement data 160 may be associated with a deformation field between a source and target image that have been provided as input to a machine learning model.

In some embodiments, a trained machine learning model (e.g., included in location determiner 172) may be an unsupervised or semi-supervised machine learning model. In some embodiments, unsupervised training may include inputting image data 142 as input to the machine learning model. In some embodiments, the machine learning model may be an encoder-decoder network and the model can be trained to map spatial transformations (e.g., affine transformations) between a source image and a target image by reconstructing the input image. In some embodiments, the machine learning model may be trained based on a training set of source and target images. In some embodiments, the training set may further include source mask images (e.g., labeled source masks).

The source image may be transformed into the target image. In some embodiments, the mapping of spatial transformations is referred to as a deformation field. The deformation field may be applied to the source image and/or a source mask. In some embodiments, measurement generator 174 may apply the deformation field to the source image (e.g., with marked measurement locations) to determine the location of the measurement locations on the target image. In some embodiments, exact point placement techniques may be used to more accurate place the measurement locations (see description of FIG. 7C). In some embodiments, the source mask may be an annotated (labeled) version of the source image. In some embodiments, the source mask is an annotation of the structural components of the source image. In some embodiments, a loss function may be used to measure the similarity between the target image and the warped source image or warped source mask. The loss calculated with the loss function may be used to update weights of the machine learning model (e.g., encoder-decoder network), e.g., via backpropagation. For a more detailed discussion of the training process refer to the description found in FIG. 7A.

In some embodiments, training a machine learning model (e.g., that is a part of location determiner 172) may include updating weights of the machine learning model based on a structural integrity loss and/or one or more similarity metrics losses (e.g., structural similarity index (SSI) loss, a Pearson correlation coefficient (PCC) loss, etc.) (e.g., to improve measurement repetition between structurally similar images). In some embodiments, training a machine learning model (e.g., that is a part of location determiner 172) may include taking a measurement of a substrate (e.g., of a structure and/or features of the substrate), adjusting a measurement of a substate (e.g., of a structure and/or features of the substrate) for consistency and accuracy, applying a deformation field to a source mask to create a warped source mask, computing a loss associated with the warped source mask, updating weights of a machine learning model based on the loss, applying a deformation field to a source to create a warped source image, computing one or more similarity metrics losses for the target image and the warped source image, updating the weights of the machine learning model based on the one or more similarity metrics losses, and/or the like. In some embodiments,

In some embodiments, the measurement data 160 is associated with the output of location determiner 172 (e.g., deformation fields). In some embodiments, computing a loss using measurement data 160 and image data 142 is associated with updating weights of a machine learning model (e.g., based on a structural integrity loss and/or similarity metrics losses) to improve measurement repetition between structurally similar images.

Performance data 152 includes historical performance data 154 and current performance data 156. Performance data 152 may be indicative of measurement quality, such as measurement repetition between structurally similar images, substrate throughput, substrate defects, etc. Performance data 152 may be indicative of whether a measurement is consistently and/or accurately taken. For example, two images may be structurally similar but are not identical. Performance data 152 may indicate that a measurement taken of a first image is similarly taken of a second structurally similar but not identical image (e.g., by image-to-image registration where each pixel is transferred from a first image to a second image such that the structure and coherence of the images is maintained).

The validation engine 184 is capable of validating a trained machine learning model (e.g., of location determiner 172) using a corresponding set of features of the validation set from data set generator 176. For example, a first trained machine learning model that was trained using a first set of features of the training set is validated using the first set of features of the validation set. The validation engine 184 determines an accuracy of each of the trained machine learning models based on the corresponding sets of features of the validation set.

The testing engine 186 is capable of testing a trained machine learning model using a corresponding set of features of a testing set from data set generator 176. For example, a first trained machine learning model that was trained using a first set of features of the training set is tested using the first set of features of the testing set. The testing engine 186 may determine whether a trained machine learning model (e.g., of location determiner 172) whether a trained machine learning model has sufficient accuracy to be used in production.

In some embodiments, machine learning model refers to the model artifact that is created by the training engine 182 using a training set that includes data inputs and corresponding target outputs (e.g., correctly classifies a condition or ordinal level for respective training inputs). Patterns in the data sets can be found that map the data input to the target output, and the machine learning model is provided mappings that captures these patterns. In some embodiments, the machine learning model uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. Non probabilistic methods may also be used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model is a multi-variate analysis (MVA) regression model.

Automated measurement component 114 provides current image data 146 (e.g., as input) to the trained machine learning model (e.g., to location determiner 172) and processes the current image data 146 using the trained machine learning model (e.g., on the input to obtain one or more outputs).

For purpose of illustration, rather than limitation, aspects of the disclosure describe the training of one or more machine learning models using historical data (i.e., prior data, historical image data 144) and providing current image data 146 into the one or more trained probabilistic machine learning models to determine measurement data 160. In other implementations, a heuristic model or rule-based model is used to determine measurement data 160 (e.g., without using a trained machine learning model). In other implementations non-probabilistic machine learning models may be used.

In some embodiments, the functions of client device 120, automated measurement server 112, and/or server machine 180 are to be provided by a fewer number of machines. For example, in some embodiments, server machine 180 and automated measurement server 112 are integrated into a single machine. In some embodiments, data set generator 176, training engine 182, validation engine 184, testing engine 186 and/or automated measurement component 114 are spread across more devices than those shown.

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of determining measurement data 160 for measurement repetition between structurally similar images associated with manufacturing systems (e.g., substrate processing equipment, manufacturing equipment, etc.), in some embodiments, the disclosure can also be generally applied to measurement repetition between structurally similar images in various other fields involving images and image processing (e.g., medical imaging, remote sensing, computer vision and robotics, geographical information systems, industrial inspection and quality control, astronomy and astrophysics, security and surveillance, forensics, agricultural and environmental monitoring, etc.).

FIG. 2 illustrates a data set generator 276 (e.g., data set generator 176 of FIG. 1) to create data sets for a machine learning model (e.g., associated with measurement repetition between structurally similar images, methods 700A-C, etc.), according to certain embodiments. In some embodiments, data set generator 276 is part of server machine 180 of FIG. 1. The data sets generated by data set generator 276 of FIG. 2 may be used to train a machine learning model (e.g., see FIG. 7B) to enable the machine learning model to automatically determine locations to be measured and/or to automatically generated measurements based on such determined locations (e.g., see FIG. 7C).

Data set generator 276 data set generator 176 creates data sets for a machine learning model (e.g., location determiner 172 of FIG. 1). Data set generator 276 creates data sets using historical image data 244. System 200 of FIG. 2 illustrates data set generator 276, data inputs 210, and target output 220 (e.g., target data such as locations to be measured).

In some embodiments, data set generator 276 generates a data set (e.g., training set, validating set, testing set) that includes one or more data inputs 210 (e.g., training input, validating input, testing input). In some embodiments, data set generator 276 does not generate target output (e.g., for unsupervised learning). In some embodiments, data set generator generates one or more target outputs 220 (e.g., for supervised learning) that correspond to the data inputs 210. The data set may also include mapping data that maps the data inputs 210 to the target outputs 220. Data inputs 210 are also referred to as “features,” “attributes,” or information.” In some embodiments, data set generator 276 provides the data set to the training engine 182, validation engine 184, or testing engine 186, where the data set is used to train, validate, or test the machine learning model (e.g., associated with measurement repetition between structurally similar images, methods 700A-C, etc.).

In some embodiments, data set generator 276 generates the data input 210 and target output 220. In some embodiments, data inputs 210 include one or more sets of historical image data 244 (e.g., source images, target images, template images, test images, source masks, etc.) (e.g., associated with measurement repetition between structurally similar images, methods 700A-C, etc.). In some embodiments, historical image data 244 includes image data from one or more types of sensors and/or metrology equipment.

In some embodiments, data set generator 276 generates a first data input corresponding to a first set of historical image data 244A to train, validate, or test a first machine learning model and the data set generator 276 generates a second data input corresponding to a second set of historical image data 244B to train, validate, or test a second machine learning model (e.g., associated with measurement repetition between structurally similar images, methods 700A-C, etc.). The first data input may correspond to a first device and/or a first structure of the first device. The second data input may correspond to a second device or a second structure of the first device.

In some embodiments, data set generator 276 generates sets of historical performance data 254 to train, validate, or test a machine learning model (e.g., associated with measurement repetition between structurally similar images, methods 700A-C, etc.).

Data inputs 210 and target outputs 220 to train, validate, or test a machine learning model include information for a particular device and/or for a particular structure of a particular device.

In some embodiments, data items from a training dataset are input into a machine learning model one at a time or in groups to train the machine learning model. The machine learning model processes the input to generate an output e.g., locations from which measurements are to be made. An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine learning model can produce.

Accordingly, the output can include one or more predictions or inferences (e.g., associated with determination of locations to be used for measurement). For example, an output prediction or inference can include one or more predictions of a deformation field, a measurement taken based on a deformation field, and so on. Processing logic determines an error (i.e., a classification error) based on the differences between the output (e.g., predictions or inferences) of the machine learning model and target labels associated with the input training data. Processing logic adjusts weights of one or more nodes in the machine learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In some embodiments, the stopping criteria is met when at least a minimum number of data points have been processed and at least a threshold accuracy is achieved. The threshold accuracy can be, for example, 70%, 80% or 90% accuracy. In some embodiments, the stopping criterion is met if accuracy of the machine learning model has stopped improving. If the stopping criterion has not been met, further training is performed. If the stopping criterion has been met, training can be complete. Once the machine learning model is trained, a reserved portion of the training dataset can be used to test the model.

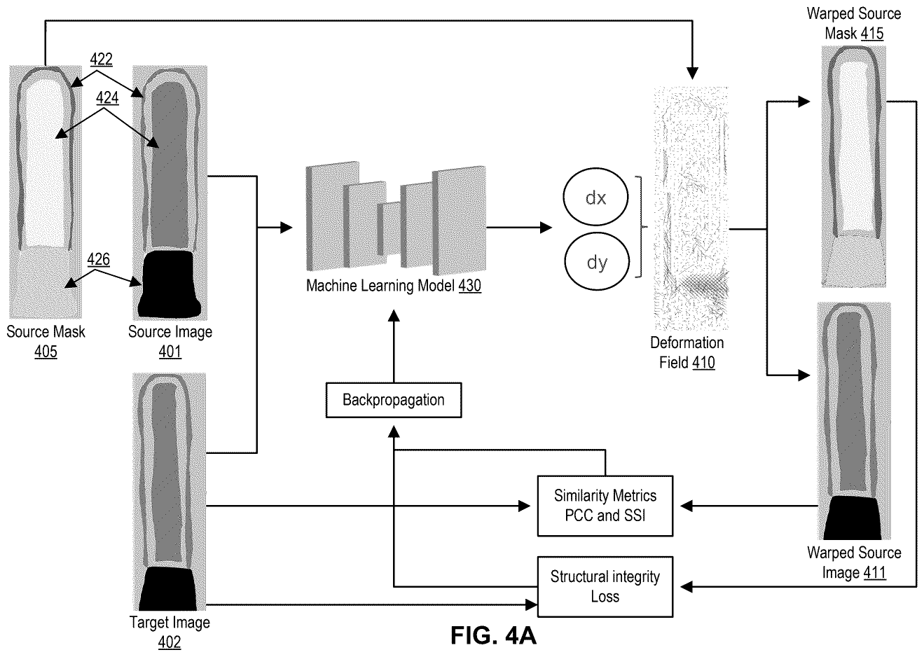

FIG. 3 is a block diagram illustrating a system 300 for generating an output including measurement locations (location data 360), according to certain embodiments. The system 300 is used to determine location data 360 via a trained machine learning model (e.g., associated with measurement repetition between structurally similar images, methods 700A-C, etc.) (e.g., location determiner 172 of FIG. 1).

At block 310, the system 300 (e.g., automated measurement system 110 of FIG. 1) performs data partitioning (e.g., via data set generator 176 of FIG. 1) of the historical image data 354 to generate the training set 302, validation set 304, and testing set 306. In some examples, the training set is 60% of the historical data, the validation set is 20% of the historical data, and the testing set is 20% of the historical data. The system 300 may generate a plurality of sets of features for each of the training set, the validation set, and the testing set.

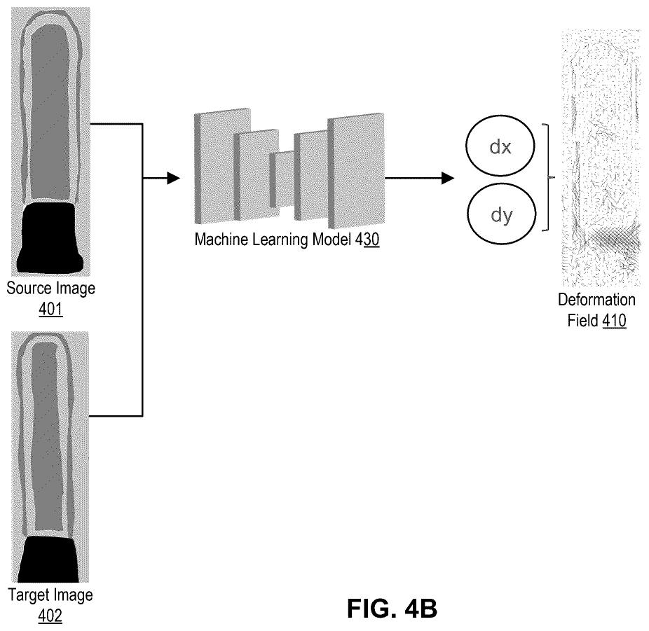

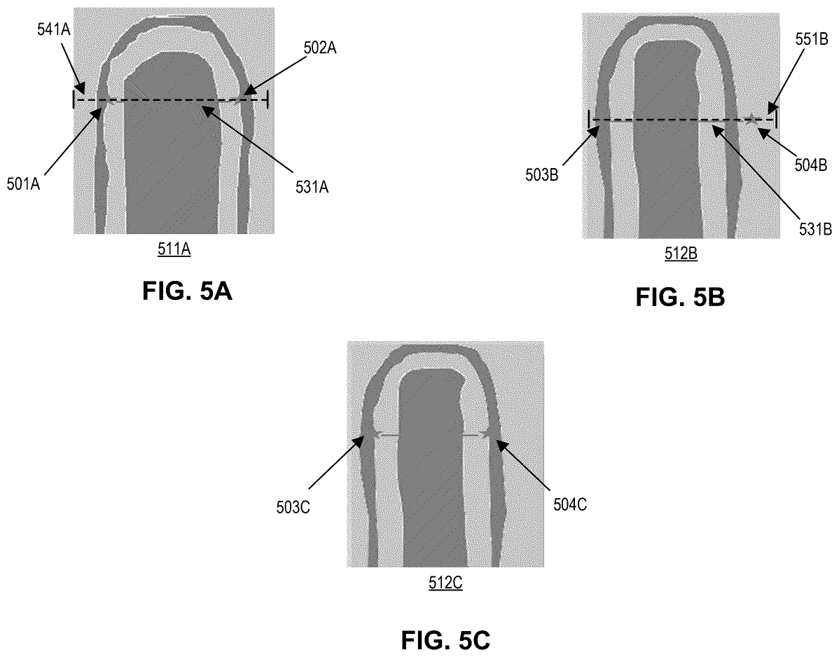

At block 312, the system 300 performs model training (e.g., via training engine 182 of FIG. 1) using the training set 302. In some embodiments, the system 300 trains multiple models using multiple sets of features of the training set 302 (e.g., a first set of features of the training set 302, a second set of features of the training set 302, etc.). For example, system 300 trains a machine learning model to generate a first trained machine learning model using the first set of features in the training set and to generate a second trained machine learning model using the second set of features in the training set. In some embodiments, training is performed according to FIG. 4.

At block 314, the system 300 performs model validation (e.g., via validation engine 184 of FIG. 1) using the validation set 304. The system 300 validates each of the trained models (e.g., associated with measurement repetition between structurally similar images, methods 700A-C, etc.) using a corresponding set of features of the validation set 304. For example, system 300 validates the first trained machine learning model using the first set of features in the validation set and the second trained machine learning model using the second set of features in the validation set. At block 314, the system 300 determines an accuracy of each of the one or more trained models (e.g., via model validation) and determines whether one or more of the trained models has an accuracy that meets a threshold accuracy. Responsive to determining that one or more of the trained models has an accuracy that meets a threshold accuracy, flow returns to block 312 where the system 300 further performs model training for those one or more models. Responsive to determining that one or more of the trained models has an accuracy that meets a threshold accuracy, flow continues to block 316 for those one or more models.

In one embodiment, at block 316, the system 300 performs model selection to select one or more of the trained machine learning models for use in production. In some embodiments, block 316 is omitted.

At block 318, the system 300 performs model testing (e.g., via testing engine 186 of FIG. 1) using the testing set 306 to test the selected model 308. The system 300 tests, using the first set of features in the testing set, the first trained machine learning model to determine the first trained machine learning model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where the system 300 further performs model training (e.g., retraining) using further training data. Responsive to determining that the selected model 308 has an accuracy that meets a threshold accuracy based on the testing set 306, flow continues to block 320. In at least block 312, the model learns patterns in the historical image data to enable the model to receive a template image with selected measurement locations and one or more target images that lack indication of measurement locations, and to output measurement locations for the one or more target images. At block 318, the system 300 applies the model on the remaining data (e.g., testing set 306) to test the predictions (e.g., the measurement locations for the target images).

At block 320, system 300 uses the trained model (e.g., selected model 308) to receive current image data 346 (e.g., current image data 146 of FIG. 1) and determines (e.g., extracts), from the trained model, location data 360. The location data 360 may indicate measurement locations from which automated measurements may be performed. In some embodiments, the trained model further outputs the measurements using the determined measurement locations. In embodiments, the trained machine learning model enables measurement repetition between structurally similar images.

In some embodiments, current image data 346 is received. In some embodiments, the model is re-trained based on the current image data 346. In some embodiments, a new model is trained based on the current image data 346.

In some embodiments, one or more of the blocks 310-320 occur in various orders and/or with other operations not presented and described herein. In some embodiments, one or more of blocks 310-320 are not to be performed. For example, in some embodiments, one or more of data partitioning of block 310, model validation of block 314, model selection of block 316, and/or model testing of block 318 are not to be performed.

FIG. 4A is a block diagram illustrating training of a machine learning model to perform image registration and/or determination of measurement locations, according to some embodiments.

In some embodiments, FIG. 4 depicts training and using a machine learning model 430. In some embodiments, the training includes using a training dataset including historical image data of a structure, the historical image data including a plurality of images of the structure. In some embodiments, with each iteration of training the machine learning model a training data input includes a source image 401 and a target image 402, which are given as training input to the machine learning model. In some embodiments, the source image 401 is a labeled image that includes a source mask 405 that comprises labels of classifications of different regions of source image 401. In some embodiments, region 422 of source image 401 and source mask 405 may be labeled as a coating, region 424 of source image 401 and source mask 405 may be labeled as a gate, and region 426 of source image 401 and source mask 405 may be labeled as a mask. In some embodiments, the machine learning model 430 includes at least one of a CNN or an encoder-decoder network.

In some embodiments, a CNN is a deep learning model that may be useful for visual data (e.g., image data). In some embodiments, a CNN can employ convolutional layers to automatically learn essential features from inputs. Such layers may use filters to extract patterns and pass them through activation functions for non-linearity. In some embodiments, pooling layers may reduce spatial dimensions, and fully connected layers may perform classification.

In some embodiments, an encoder-decoder network may be useful for sequence-to-sequence tasks, where the input and output have different lengths or structures. In some embodiments, an encoder processes the input sequence (e.g., using recurrent neural networks (RNNs) or transformers) to create a condensed representation (e.g., called the context vector). In some embodiments, the decoder generates the output sequence based on the context vector (e.g., using an RNN or transformer network).

In some embodiments, source images 401 are labeled to create source mask 405 for the source image. In some embodiments, source mask 405 is an annotation of the structural components of the source image. For example, a coating, a gate, a drain, a mask, and/or the like may be labeled to create the source mask. In some embodiments, region 422 of source image 401 and source mask 405 may be labeled as a coating, region 424 of source image 401 and source mask 405 may be labeled as a gate, and region 426 of source image 401 and source mask 405 may be labeled as a mask. In some embodiments, source image 401 is manually labeled. In some embodiments, source image 401 is automatically labeled (e.g., using another trained machine learning model that has been trained to perform pixel-level classification and/or segmentation of images of devices.

In some embodiments, source image 401 and a target image 402 may be provided as training input to the machine learning model 430. In some embodiments, source mask 405 may also be provided as training input to the machine learning model 430. In some embodiments, a training data set may include a plurality of images. Multiple inputs may be assembled from the plurality of images. Each input may include a selection of a first image to act as a source image, a mask or other label or annotation associated with the source image, and a second image to act as a target image. In embodiments, each selected source image should be associated with a mask or other pixel-level annotations. Target images may or may not be associated with masks. In instances where the target images are associated with masks, the masks associated with the target images may not be used for training purposes. For training of machine learning model 430, many training data inputs may be assembled, and may be input into the machine learning model 430 one at a time to perform an iterative training process.

In some embodiments, the number of images that are unlabeled may be substantially larger than the number of images that are labeled (and that may function as source images). However, this is not a problem, as each different combination of a source image and a target image may function as a different training data input. For example, the same source image 401 may be paired with multiple different target images to form different data inputs. Accordingly, even a small number of labeled images may be used to form a large number of data inputs for training machine learning model 430. In an example, the plurality of images that are labeled may be 4 images out of a total of 100 images. Even this small number of images, with an even smaller number of labeled images, can result in a much larger number of training data inputs. For example, 4 labeled images and 100 total images may result in about 400 different data inputs.

In some embodiments, in each iteration of training the machine learning model 430 a source image 401 and a target image 402 of a data input are input into the machine learning model 430. The machine learning model performs a non-rigid registration of the source image 401 to the target image 402 and outputs deformation field 410 (also referred to as a registration flow) that indicates transformations to apply to the source image 401 to achieve target image 402.

In the field of image processing and computer vision, a deformation field, also known as a displacement field or a registration field or a registration flow, is a fundamental concept used in various tasks such as image registration and image warping. It is a mathematical representation of the spatial correspondence between two images or image volumes. The deformation field includes a set of vectors that represent the spatial displacement of each pixel or voxel in one image to its corresponding location in the other image. Each vector in the field indicates how much a pixel should be moved in the x, y (and in 3D applications, z) directions to align with its corresponding pixel in the reference image. The deformation field can be represented in different ways depending on the application, but one common representation is a grid of vectors or a dense matrix. Each element in the grid corresponds to a specific pixel or voxel location in the source image, and its value represents the displacement needed to map that location to the target image.

In registration, each pixel in the source image is transferred or registered to a pixel in the target image in a manner that maintains structure and coherence. Registration between the source and target image may be achieved based on similarity of the two images. Rigid registration is the simplest method to transfer each point and includes rotation and translation of the original image. However, rigid registration does not account for different shapes between the source and target images, which are typical in semiconductor manufacturing. Affine registration allows for shearing and scaling of the source image to register the source image to the target image, but also doesn't account for changes in shape between the images. Non-rigid registration is capable of aligning images that have slightly different shapes. For non-rigid registration, local deformations may be made in the source image to register it to the target image. The local deformations may include moving one or more points independently of one or more other points to cause points of the source image to align with corresponding points of the target image. Non-rigid transformation can preserve more complex structural deformities and variability between images, which may not be preserved with rigid registration or affine registration. Accordingly, in embodiments machine learning model 430 performs non-rigid registration between source image 401 and target image 402.

In embodiments, machine learning model 430 outputs a deformation field 410 (e.g., a registration field) between the source image and the target image based on a result of performing registration (e.g., non-rigid registration) between the source image 401 and the target image 402. In some embodiments, deformation field 410 may represent a spatial mapping between corresponding points in the source image 401 and the target image 402, indicating the local displacements or deformations that result in alignment between the two images. In embodiments, the deformation field 410 is a two-dimensional deformation field, and includes a magnitude and direction associated with each pixel in the source image 401 along the x-axis (dx) and along the y-axis (dy).

The deformation field 410 may be applied to the source image 401 to generate a warped source image 411. In embodiments, deformation field 410 may be applied to source image 401 to generate a warped version of the source image 401 that has been warped or otherwise modified to resemble the target image as a result of the non-rigid registration. In some embodiments, deformation field 410 may also be applied to source mask 405 to create a warped source mask 415.

Once fully trained, the deformation field 410 may be applied to source image 401 to reproduce target image 402. However, until the machine learning model 430 is fully trained, the deformation field 410 may not be accurate, and application of deformation field 410 to the source image 401 may not accurately reproduce target image 402. Accordingly, one or more errors may be determined based at least in part on the deformation field 410. In one embodiment, errors are determined based on applying the deformation field 410 to the source image 401 (to result in warped source image 411) and to source mask 405 (to result in warped source mask 415). The warped source image 411 and warped source mask 415 may be compared with target image 402 to determine differences therebetween. These differences may then be used to update nodes of machine learning model 430 using backpropagation. In some embodiments, one or more similarity metrics are computed based on comparison of the warped source image 411 to the target image 402. In some embodiments, multiple (e.g., two) similarity metrics are computed based on comparison of the warped source image 411 to the target image 402. In some embodiments, an additional similarity metric is computed based on comparison of the warped source mask 415 to the target image 402. Each of the similarity metrics may be used to update weights associated with nodes of the machine learning model 430 (e.g., via backpropagation) to improve an ability of the machine learning model 430 to register source images to target images (e.g., to improve an accuracy of a deformation field 410 outputs by machine learning model 430( ) that can be applied to a source image to cause the source image to match or approximately match a target image).

In the context of comparing a target image and a source image, a similarity metric loss function is a mathematical function used to quantify the similarity or dissimilarity between these two images. A goal of using such a loss function is to train a model to minimize the difference between the target and source images, thus improving the model's ability to perform tasks like image comparison, image registration, image reconstruction, or image retrieval. There are various similarity metrics loss functions commonly used, depending on the specific task and the characteristics of the images. Some of the popular ones include:
1) Mean Squared Error (MSE) Loss: This is a basic and widely used loss function that calculates the average squared difference between corresponding pixels of the target and source images. It penalizes larger differences more heavily;
2) L1 Loss (Mean Absolute Error): Similar to MSE, but it calculates the average absolute difference between the pixels. L1 loss is less sensitive to outliers than MSE;
3) Structural Similarity Index (SSIM) Loss: SSIM is a perception-based metric that measures the similarity between two images by comparing luminance, contrast, and structure. It takes into account both local and global image features;
4) Cosine Similarity Loss: This measures the cosine of the angle between the target and source image vectors, considering them as high-dimensional feature vectors;
5) Triplet Loss: Triplet loss is commonly used in tasks like image retrieval and facial recognition. It aims to ensure that the distance between the target and source images is smaller than the distance between the target and other non-matching images;
6) Contrastive Loss: This loss function encourages similar images to be closer together in the feature space and dissimilar images to be farther apart; and
7) Pearson correlation coefficient (PCC): a statistical measure of the linear relationship between two continuous variables. It is used to quantify how well the relationship between the two variables can be described by a straight line.

In some embodiments, the similarity metrics computed based on comparison of the warped source image 411 and the target image include a structural similarity index (SSI) loss and/or a Pearson correlation coefficient (PCC) loss. Other similarity metrics may additionally or alternatively be used.

In the context of comparing a target image and a source image, the Pearson correlation coefficient can be utilized as a similarity metrics loss. To do this, one should first convert the images into one-dimensional arrays or vectors. Each element of the vector represents a pixel intensity value or a feature value of the image. Then, the Pearson correlation coefficient can be calculated between the target image vector and the source image vector. The Pearson correlation coefficient ranges from −1 to +1. A value of +1 indicates a perfect positive linear relationship between the two images, meaning that they vary directly and proportionally. A value of −1 indicates a perfect negative linear relationship, implying that one image increases while the other decreases. A value close to 0 suggests little or no linear relationship between the two images. In embodiments, to use the Pearson correlation coefficient as a similarity metrics loss, the goal may be to maximize the PCC during the training process. In this way, the machine learning model 430 learns to find patterns and similarities between the target and source images that can be described by a linear relationship.

In some embodiments, PCC loss measures linear correlation between two sets of numerical data. For example, images may be represented as numerical data, such as pixel values or extracted features. Images may be converted into feature vectors or matrices. The vectors may then be flattened or reshaped for alignment and the PCC between the two vectors may be computed. In some embodiments, a higher positive PCC indicates more similarity/correlation, while negative values indicate dissimilarity/uncorrelation. In some embodiments, a computed SSI loss may have a value ranging from −1 to 1, where a value from −1 to 0 indicates negative correlation, a value of 0 indicates no correlation, and a value from 0 to 1 indicates positive correlation. In some embodiments, weights of the machine learning model may be updated based on the one or more similarity metrics losses.

The Structural Similarity Index (SSIM) is perceptual metric to assess the similarity between two images. It is designed to capture the structural information and visual quality of an image by measuring the perceived changes in structural information between a reference (original or source) image and a distorted (target) image. The SSIM index takes into account three main components of an image: luminance, contrast, and structure. It is based on the understanding that the human visual system is highly sensitive to these aspects of an image. The SSIM index ranges from −1 to 1, where 1 represents a perfect match between the two images, 0 indicates no similarity, and −1 implies a perfect mismatch. The formula for calculating the SSIM index is as follows:

$$SSIM ( x , y ) = l ( x , y ) \cdot c ( x , y ) \cdot s ( x , y )$$

Where l(x, y) is a luminance similarity, c(x, y) is a contrast similarity, and s(x, y) is a structure similarity. Luminance similarity measures the similarity of the overall brightness and intensity between the two images. It is computed using the mean and variance of pixel intensities in both images. Contrast similarity quantifies the difference in contrast or the local variations in pixel intensities. It is calculated based on the covariance of pixel intensities in the reference and distorted images. Structure similarity accounts for the patterns and structures in the images. It is determined by the covariance of pixel intensities after accounting for luminance and contrast information. Higher SSIM values indicate greater structural similarity between the images.

In some embodiments, a structural integrity loss may be computed for the warped source mask 415. In some embodiments, computing a structural integrity loss may refer to a calculated value quantifying the degradation or distortion of important visual features that define the structure of an image (e.g., source image 401). A structural integrity loss may be used to measure the deviation between an original image (e.g., source mask 405) and a processed image (e.g., warped source mask), indicating the extent of structural information loss. In some embodiments, the structural integrity loss is computed on the warped source mask between the labeled pixels (source mask). In some embodiments, differences between neighboring pixels are calculated as 1 if they are different and 0 if they are the same. In some embodiments, the structural integrity loss may be expressed by the equation:

$${V}_{a n i s o} ( y ) = {\sum }_{i , j} \sqrt{{\vert {y}_{i + 1 , j} - {y}_{i , j} \vert}^{2}} + \sqrt{{\vert {y}_{i , j + 1} - {y}_{i , j} \vert}^{2}} = {\sum }_{i , j} \vert {y}_{i + 1 , j} - {y}_{i , j} \vert + \vert {y}_{i , j + 1} - {y}_{i , j} \vert$$

In some embodiments, weights of the machine learning model may be updated based on the loss (e.g., by backpropagation).

In some embodiments, weights of the machine learning model may be updated based on the loss and the one or more similarity metrics losses (e.g., by backpropagation). In some embodiments, the structural integrity loss and the one or more similarity metrics losses may be combined, and weights of the machine learning model may be updated based on the combined structural integrity loss and the one or more similarity metrics losses. In some embodiments, each of the computed similarity metrics losses is used to determine adjustments to be made to weights associated with nodes of machine learning model 430 via backpropagation. By computing multiple different similarity loss functions and updating the machine learning model 430 based on each of the similarity loss functions, training of the machine learning model 430 may be achieved more quickly and with a smaller set of training data than would be otherwise achievable.

FIG. 4B is a block diagram illustrating using a machine learning model to perform image registration between an input source and target image, according to some embodiments. In some embodiments, an inference phase of machine learning model 430 may be performed after the machine learning model 430 is trained. The inference phase includes inputting source image 401 and target image 402 into the machine learning model 430 and receiving a deformation field 410 as output. In some embodiments, an input comprising a template image and a test image, where the template image comprises labels for a first location and a second location associated with a first measurement of the template image may be received. In some embodiments, the first and second location are marked on the source image. In some embodiments, a separate input indicating coordinates of the first and second location are provided together with the source image. The output deformation field may be applied to the source image to recreate the target image, along with indications of warped coordinates of the first and second location from the source image in the target image. In some embodiments, the template image (e.g., source image) and a test image (e.g., target image) may be provided as input to a trained machine learning model. In some embodiments, an output including a third location and a fourth location on the test image, the third location and the fourth location are usable to determine the first measurement of the test image, may be received from the trained machine learning model.

In embodiments, in order to replicate a measurement from a template or source image (in which locations to use for one or more measurements have been marked) to other images accurately, at least two points may be registered between source and target images for measurement. Using registration flow, two points of each measurement may be registered to determine locations on target images from which to generate a measurement. A measurement may then be automatically generated using the determined points (e.g., by measuring a distance between the points in the target image or warped source image).

The output locations as output by the trained machine learning model that are to be used for measurements in the target image may be close to correct but may not be entirely correct. Accordingly, in some embodiments one or more additional operations are performed on the source image, on the warped source image and/or on the target image to improve an accuracy of the locations. In some embodiments, use of image registration in the trained machine may alleviate users (e.g., engineers) from doing many of manual steps to align structures.

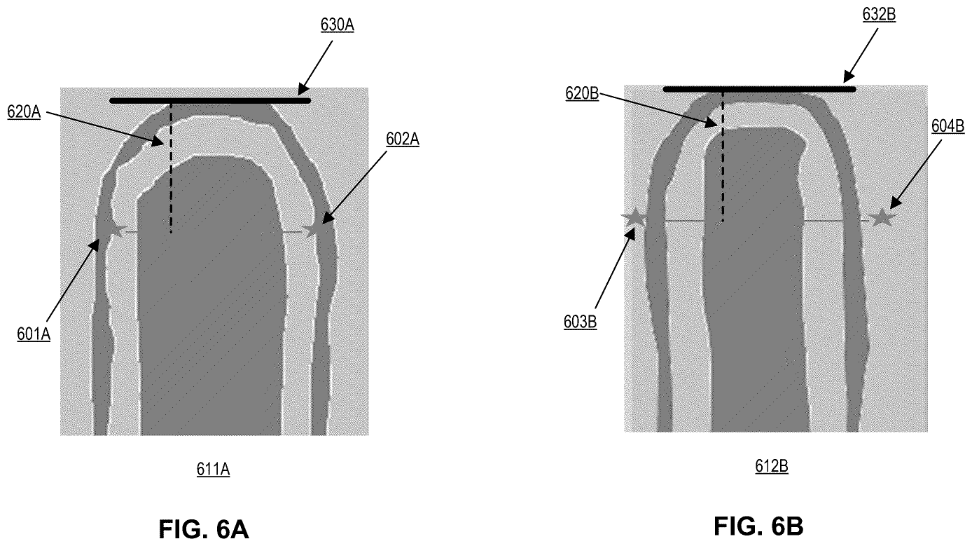

FIGS. 5A-C are examples of exact point placement, according to some embodiments.

With reference to FIG. 5A, in some embodiments, exact point placement may include receiving an input, including a template image 511A and a test image, where template image 511A includes labels for a first location 501A and a second location 502A on template image 511A associated with a first measurement 531A of template image 511A (also referred to as a source image). In some embodiments, first location 501A may be coordinates of a specific pixel on template image 511A. In some embodiments, a template image 511A and a test image (also referred to as a target image) may be provided as input to a trained machine learning model.

In some embodiments, a template signal may be extracted along a first line 541A intersecting first location 501A and second location 502A on template image 511A.

With reference to FIG. 5B, in some embodiments, an output including a test image 512B (e.g., warped source image, warped template image, etc.) with a marked third location 503B (e.g., corresponding to first location 501A of FIG. 5A) and a fourth location 504B (e.g., corresponding to second location 502A of FIG. 5A) may be output by the trained machine learning model and may be associated with a second measurement 531B of test image 512B (e.g., also referred to as warped source image, warped template image, etc.). In some embodiments, the trained machine learning model outputs a deformation field which processing logic applies to the template image 511A of FIG. 5A to generate a test image 512B (e.g., warped template image) that corresponds to the target image (e.g., is warped using the deformation field to look like the target image). As shown in FIG. 5B, the test image 512B (e.g., warped template image) may include a warped first location 501A of FIG. 5A that corresponds to third location 503B and a warped second location 502A of FIG. 5A that corresponds to fourth location 504B on test image 512B (e.g., warped template image) associated with second measurement 531B of test image 512B.

In some embodiments, a test signal may be extracted along a second line 551B intersecting a third location 503B and a fourth location 504B on a test image 512B (e.g., warped template image, warped source image, etc.).

In some embodiments, a warped source image or warped template image includes an adjusted third location and an adjusted fourth location. In some embodiments, adjusted third location and adjusted fourth location are adjusted versions of third location 503B and fourth location 504B of FIG. 5B using exact point placement. For more details, see the explanations in FIGS. 7A-C.

In an example of exact point placement using DTW as seen in the FIGS. 5A-C, third location 503B, and fourth location 504B may be adjusted in the test image (e.g., warped source image) to match the location of the placed points (e.g., first location 501A, second location 502A) in the template image. In some embodiments, DTW may be used (in terms of signal similarity) to match the location of the automatically generated point on the test image to the placed points on the test image.

In some embodiments, at least one of a third location (e.g., third location 503C of FIG. 5C) or fourth location 504C of FIG. 5C may be adjusted using a DTW transformation of the test signal to the template signal to produce a test signal after DTW. In some embodiments, the third location may represent the location of a measurement point before a DTW, and the measurement point may be adjust based on the DTW transformation. In some embodiments, the test signal may be a query sequence and template signal may be a reference sequence. In some embodiments, the template signal and the test signal each include an average of pixel values of pixels along a first line (e.g., first line 541A of FIG. 5A) and a second line (e.g., second line 551B of FIG. 5B), respectively. In some embodiments, the average of the pixel values along the first line and second line may be an average grey level value of the pixels and/or the like.

In some embodiments, following the DTW transformation of test signal to the template signal to test signal after DTW is generated. In some embodiments, a third location after DTW (e.g., corresponding to point after DTW) corresponds to a more accurate point placement on the test signal after DTW.

In some examples, exact point placement includes using a local ratio adjustment, according to some embodiments. In some embodiments, for more finely adjusted measurement repetition on the template image, the ratio of a closest local minimum and maximum on the signals in relation to each location on the signals can be found.

The ratio can be calculated as (point−local_min)/(local_max−local_min) and after calculating for template image, the point in the test image can be fine adjusted.

In some embodiments, a template signal local maximum may be identified, where template signal local maximum is a closest local maximum to a first point on a template signal corresponding to a first location (e.g., first location 501A of FIG. 5A) on a template image (e.g., template image 511A of FIG. 5A).

In some embodiments, a template signal local minimum may be identified, where template signal local minimum is a closest local minimum to a first point on the template signal corresponding to the first location (e.g., first location 501A of FIG. 5A) on the template image (e.g., template image 511A of FIG. 5A).

In some embodiments, a test signal local maximum may be identified, where test signal local maximum is a closest local maximum to a point after DTW on test signal corresponding to a third location (e.g., third location 503B of FIG. 5B) on the test image (e.g., warped source image, test image 512B of FIG. 5B, warped template image, etc.).

In some embodiments, a test signal local minimum may be identified, where test signal local minimum is a closest local minimum to the point after DTW on test signal corresponding to the third location (e.g., third location 503B of FIG. 5B) on the test image (e.g., warped source image, test image 512B of FIG. 5B, warped template image, etc.).

In some embodiments, point represents point after DTW before the DTW transformation is applied.

In some embodiments, a first ratio may be calculated. The first ratio representing a relationship between a proximity of the first point on the template signal to the template signal local maximum and a proximity of the first point on the template signal to the template signal local minimum.

In some embodiments, the third location (e.g., third location 503B of FIG. 5B) may be adjusted so that a second ratio representing a relationship between a proximity of the point after DTW on the test signal to the test signal local maximum and a proximity of the point after DTW on the test signal to the test signal local minimum is approximately equal to the first ratio. In some embodiments, the third location 503B of the test image 512B (e.g., warped template image) may correspond to the first location 501A of the template image 511A after non-rigid registration of the test image to the template image 511A.

In some embodiments, following exact point placement (e.g., using DTW and/or local ratio adjustment by adjusting locations causing ratios to be approximately equal) the third location 503C of FIG. 5C may be more accurately placed on warped source image 512C and enables a more precise measurement of test image. Similarly, fourth location 504B may be adjusted (e.g., to get fourth location 504C) enabling a more precise and accurate measurement of the test image.

In some embodiments, the processes described and performed on a single location (e.g., of a measurement) can be applied to a second location, third location, fourth location, and so on. In some embodiments, the method can also accommodate multiple template images when each signal of each designated location of a template image goes through a DTW with the test image and the final location of the points on the test image are the average of each approximation (e.g., from each template image) giving a more robust approximation of the location on the test image (e.g., measurement repetition).

In some embodiments, exact point placement may be robust to noise and other artifacts by predicting measurement location on a template image based on a DTW method and not simple edge detection.

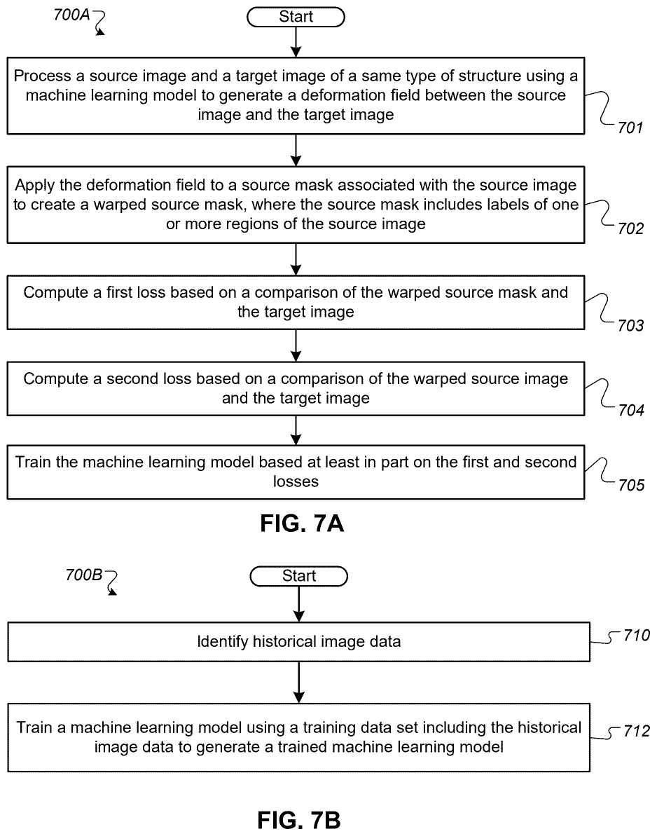

FIGS. 6A-B are an examples of exact point placement using a reference point, according to some embodiments. In some embodiments, to restrict the motion of the points, references such as reference points and/or reference lines may be used.

With reference to FIG. 6A, in some embodiments, the reference point may be a reference line (e.g., first reference line 630A). In some embodiments, the first location 601A and the second location 602A of the template image 611A are positioned at a vertical distance 620A from a first reference line 630A. With reference to FIG. 6B, the third location 603B and the fourth location 604B of the test image 612B are positioned at a vertical distance 620B (approximately equal to the vertical distance 620A of FIG. 6A) from a second reference line 632B. In some embodiments, first reference line 630A and second reference line 632B may be positioned at a feature (e.g., a top of a feature or a bottom of a feature such as a coating, drain, source, etc.) of template image 511A and test image 512B, respectively.

FIGS. 7A-C are flow diagrams of methods 700A-C associated with measurement repetition between structurally similar images, according to certain embodiments. In some embodiments, methods 700A-C are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In one implementation, method 700A can be performed by a computer system, such as computer system architecture 100 of FIG. 1. In other or similar implementations, one or more operations of method 700A can be performed by one or more other machines not depicted in the figures. In some embodiments, methods 700A-C are performed, at least in part, by automated measurement system 110. In some embodiments, method 700A is performed by client device 120 (e.g., automated measurement component 114) and/or automated measurement system 110 (e.g., automated measurement component 114). In some embodiments, method 700B is performed by server machine 180 (e.g., training engine 182, etc.). In some embodiments, method 700C is performed by predictive server 112 (e.g., automated measurement component 114) and/or client device 120 (e.g., automated measurement component 114). In some embodiments, a non-transitory storage medium stores instructions that when executed by a processing device (e.g., of automated measurement system 110, of server machine 180, of predictive server 112, of client device 120, etc.), cause the processing device to perform one or more of methods 700A-C.

For simplicity of explanation, methods 700A-C are depicted and described as a series of operations. However, operations in accordance with this disclosure can occur in various orders and/or concurrently and with other operations not presented and described herein. Furthermore, in some embodiments, not all illustrated operations are performed to implement methods 700A-C in accordance with the disclosed subject matter. In addition, those skilled in the art will understand and appreciate that methods 700A-C could alternatively be represented as a series of interrelated states via a state diagram or events.

FIG. 7A is a flow diagram of a method associated with measurement repetition between structurally similar images, according to aspects of the present disclosure.

Referring to FIG. 7A, in some embodiments, the processing logic implementing the method 700A trains a machine learning model using a training dataset including historical image data of a structure, the historical image data including a plurality of images of the structure. In some embodiments, the training includes blocks 701 through 706. In some embodiments, at block 701 the processing logic implementing the method 700A processes a source image and a target image of a same type of structure using a machine learning model to generate a deformation field between the source image and the target image.

At block 702, the processing logic applies the deformation field to a source mask associated with the source image to create a warped source mask, where the source mask includes labels of one or more regions of the source image. In some embodiments, the processing logic generates the source mask based on labeling of one or more regions of the source image. In some embodiments, the processing logic applies the deformation field to the source image to create a warped source image.

At block 703, the processing logic computes a first loss based on a comparison of the warped source mask and the target image. In some embodiments, the first loss based on the comparison of the warped source mask and the target image may include a structural integrity loss.

At block 704, the processing logic computes a second loss based on a comparison of the target image and the warped source image. In some embodiments, the processing logic computes one or more similarity metrics losses based on a comparison of the target image and the warped source image. In some embodiments, the one or more similarity metrics losses based on the comparison of the target image and the warped source image may include a structural similarity index (SSI) loss and a Pearson correlation coefficient (PCC) loss.

As described above, in some examples more than one loss may be computed. For example, the processing logic may compute the first loss based on a comparison of the target image and the warped source image (e.g., a similarity metrics loss). The processing logic may also compute a second loss based on a comparison of the warped source mask and the target image. In some examples, both the first loss (e.g., based on a comparison of the target image and the warped source image) and the second loss (e.g., based on a comparison of the warped source mask and the target image) may be used in training a machine learning model as described in block 705. In some embodiments, any number of losses (e.g., a first loss, second loss, third loss, and so on) may be computed and may be used in training a machine learning model as described in block 705.

At block 705, the processing logic trains the machine learning model based at least in part on the first or second loss. In some embodiments, the processing logic trains the machine learning model based at least in part on the first and second losses. In some embodiments, the processing logic trains the machine learning model based at least in part on the one or more similarity metrics losses. In some embodiments, the processing logic trains the machine learning model based on both the first loss (e.g., based on a comparison of the warped source mask and the target image) and the second loss (e.g., based on a comparison of the target image and the warped source image). In some embodiments, the second loss may include multiple similarity metrics losses including a structural similarity index (SSI) loss, a Pearson correlation coefficient (PCC) loss, and/or the like. In some embodiments, the machine learning model may include at least one of a CNN or an encoder-decoder network.

In some embodiments, the processing logic may further receive an input comprising a template image and a test image, where the template image comprises labels for a first location and a second location associated with a first measurement of the template image. In some embodiments, the processing logic may further provide the template image and a test image as input to the trained machine learning model, where the trained machine learning model outputs a deformation field based on non-rigid registration of the template image to the test image. In some embodiments, the processing logic may receive, from the trained machine learning model, an output including a third location and a fourth location on the test image, the third location and the fourth location are usable to determine the first measurement of the test image. In some embodiments, the third location of the test image may correspond to the first location of the template image after non-rigid registration of the test image to the template image. In some embodiments, during registration each location from a first image (e.g., source image) is translated to a second image (e.g., target image) via vectors that describe the motion (e.g., registration flow represented as a deformation field) of the source image to the target image.

In some embodiments, in order to replicate the first measurement from the template image to the test image accurately, two locations (e.g., the first location and second location of the test image) should be registered. Using registration flow, the locations of the measurement on the template image are registered and a corresponding measurement is repeated on the test image.

In the template image, the placed measurements are done manually. On the test image the measurements are repeated using registration. In some embodiments, repeated measurements may be further adjusted using exact point placement techniques (e.g., described in FIGS. 5A-C, 6, and 7C).

In some embodiments, the first location and the second location of the template image are positioned at a vertical distance from a first reference point, and the third location and the fourth location of the test image are positioned at the vertical distance from a second reference point. In some embodiments, a reference point may be a reference line, or a reference line may include a reference point.

In some embodiments, for replication of the measurement from a template image to other images (e.g., a test image) a signal (e.g., template signal and/or test signal) needs to be extracted in the vicinity of each placed point (e.g., location, measurement point, etc.). In some embodiments, the processing logic may further extract a template signal along a first line intersecting the first location and the second location on the template image. In some embodiments, the processing logic may further extract a test signal along a second line intersecting the third location and the fourth location on the test image. In some embodiments, the processing logic may further adjust at least one of the third location or the fourth location using a DTW transformation of the test signal to the template signal. In some embodiments, the template signal and the test signal each include an average of pixel values of pixels along the first line and the second line, respectively.

In some embodiments, the template signal and test signal may be extracted in the direction of the measurement (e.g., horizontally). In some embodiments, the signal may be extracted parallel to the first line intersecting the first and second locations on the template image and the second line intersecting the third and four locations on the test image.

In some embodiments, the processing logic may further identify a template signal local maximum, where the template signal local maximum is a closest local maximum to a point on the template signal corresponding to the first location on the template image to a point on the template signal corresponding to the first location on the template image. In some embodiments, the processing logic may further identify a template signal local minimum, wherein the template signal local minimum is a closest local minimum to a point on the template signal corresponding to the first location on the template image.

In some embodiments, the processing logic may further identify a test signal local maximum, where the test signal local maximum is a closest local maximum to a point on the test signal corresponding to the third location on the test image.

In some embodiments, the processing logic may further identify a test signal local minimum, where the test signal local minimum is a closest local minimum to a point on the test signal corresponding to the third location on the test image.

In some embodiments, the processing logic may further calculate a first ratio representing a relationship between a proximity of the point on the template signal to the template signal maximum and a proximity of the point on the template signal to the template signal minimum. In some embodiments, the processing logic may further adjust the third location so that a second ratio representing a relationship between a proximity of the point on the test signal to the test signal maximum and a proximity of the point on the test signal to the test signal minimum is approximately equal to the first ratio.

In some embodiments, the first and second ratios can be calculated by subtracting the y-value of the signal local minimum from the y-value of the first location and dividing by the difference between y-value of the signal local maximum and the y-value of the signal local maximum.

In some embodiments, any number of locations may be identified on a template image and the locations may be registered to a test image. Such locations may correspond to multiple measurements.

In some embodiments, multiple template images may have identified locations and may go through a DTW transformation with the test image. The repeated measurement (e.g., locations corresponding to measurements) may be based on the average of all of the approximations of the template images DTWs.

FIG. 7B is a flow diagram of a method for training a machine learning model (e.g., location determiner 172 of FIG. 1) for determining predictive data (e.g., measurement data 160 of FIG. 1) associated with measurement repetition between structurally similar images, according to aspects of the present disclosure.

Referring to FIG. 7B, at block 710 of method 700B, the processing logic identifies historical image data (e.g., historical image data 144, historical images, etc.). Historical image data may include images from historical substrates, historical features of substrates, historical structures of substrates, and/or the like.

In some embodiments, at block 712, the processing logic trains a machine learning model using a training data set including the historical image data and target output including historical performance data (e.g., deformation fields, a warped source mask, a loss associated with the warped source mask, one or more similarity metrics losses for a target image and the warped source image, historical performance data 154 of FIG. 1, etc.) to generate a trained machine learning model. Historical performance data may include historical measurements of substrates (e.g., features of substrates, structures of substrates, etc.) and/or data from historical images such as values of one or more of accuracy of measurements, consistency of measurements, and/or the like. Performance data, including historical performance data, may include computations of loss associated with the warped source mask (e.g., a structural integrity loss) following image registration for measurement repetition between structurally similar images, computations of similarity metrics losses (e.g., structural similarity index (SSI) loss, a Pearson correlation coefficient (PCC) loss, etc.) following image registration for measurement repetition between structurally similar images, etc.

In some embodiments, at least a portion of the performance data 152 is associated with a quality of measurements of substrates produced by the manufacturing equipment 124. Performance data 152 may be indicative of whether a measurement is properly and/or accurately taken. For example, two images may be structurally similar but are not identical. Performance data 152 may indicate that a measurement taken of a first image is similarly taken of a second structurally similar but not identical image (e.g., by image-to-image registration where each pixel is transferred from a first image to a second image such that the structure and coherence of the images is maintained).

The historical performance data may be associated with quality of image registration, such as by computing a loss associated with the warped source mask (e.g., a structural integrity loss) and/or similarity metrics losses (e.g., structural similarity index (SSI) loss, a Pearson correlation coefficient (PCC) loss, etc.) following image registration for measurement repetition between structurally similar images (e.g., of historical substrates)).

FIG. 7C is a method 700C for using a trained machine learning model (e.g., location determiner 172 of FIG. 1) associated with measurement repetition between structurally similar images and causing performance of a corrective action.

Referring to FIG. 7C, at block 720 of method 700C, receives an input including a template image and a test image, wherein the template image comprises labels for a first location and a second location associated with a first measurement of the template image.

At block 722, the processing logic provides the template image and the test image as input to a trained machine learning model (e.g., trained via block 712 of FIG. 7B), where the trained machine learning model outputs a deformation field based on non-rigid registration of the template image to the test image. In some embodiments, the trained machine learning model may be associated with measurement repetition between structurally similar images (e.g., image data). In some embodiments, the machine learning model includes at least one of a CNN or an encoder-decoder network.

At block 724, the processing logic determines, based on application of the deformation field to the template image, a third location and a fourth location on the test image that correspond to the first location and the second location, respectively, on the template image, where the third location and the fourth location are usable to determine the first measurement of the test image.

At block 726, the processing logic extracts a template signal along a first line intersecting the first location and the second location on the template. image.

At block 728, the processing logic extracts a test signal along a second line intersecting the third location and the fourth location on the test image.

In some embodiments, the template signal and the test signal each comprise an average of pixel values of pixels along the first line and the second line, respectively.

At block 730, the processing logic adjusts at least one of the third location or the fourth location using a DTW transformation of the test signal to the template signal.

At block 732, the processing logic identifies a template signal local maximum, where the template signal local maximum is the closest local maximum to a point on the template signal corresponding to the first location on the template image.

At block 734, the processing logic identifies a template signal local minimum, where the template signal local minimum is a closest local minimum to a point on the template signal corresponding to the first location on the template image.

At block 736, the processing logic identifies a test signal local maximum, where the test signal local maximum is a closest local maximum to a point on the test signal corresponding to the third location on the test image.

At block 738, the processing logic identifies a test signal local minimum, where the test signal local minimum is a closest local minimum to a point on the test signal corresponding to the third location on the test image.

At block 740, the processing logic calculates a first ratio representing a relationship between a proximity of the point on the template signal to the template signal maximum and a proximity of the point on the template signal to the template signal minimum.

At block 742, the processing logic adjusts the third location so that a second ratio representing a relationship between a proximity of the point on the test signal to the test signal maximum and a proximity of the point on the test signal to the test signal minimum is approximately equal to the first ratio.

In some embodiments, the third location of the test image corresponds to the first location of the template image after non-rigid registration of the test image to the template image.

In some embodiments, the first location and the second location of the template image are positioned at a vertical distance from a first reference point, and the third location and the fourth location of the test image are positioned at the vertical distance from a second reference point. In some embodiments, a reference point may be a reference line, or a reference line may include a reference point.

In some embodiments, blocks 701-708 of FIG. 7A includes training a machine learning model to repeat measurements between structurally similar images based on a source image, a target image, and/or a source mask. In some embodiments the trained machine learning model may be used to repeat measurements between structurally similar images based on a source image, a target image, and/or a source mask.

In some embodiments, image data 142 may include template images, test images, source images, target images, source masks, etc., and the trained machine learning model of block 722 was trained using data input including historical template images, test images, source images, target images, and/or source masks and target output including historical performance data 154 (e.g., deformation fields, measurements, etc.).

In some embodiments, image data (e.g., e.g., template images, test images, source images, target images, source masks, etc.) and the trained machine learning model of block 722 was trained using data input including historical template images, test images, source images, target images, and/or source masks and target output including historical performance data 154 (e.g., deformation fields measurements, etc.) The measurement data 160 of block 724 may be associated with predicted performance data (e.g., performance data of the repeated measurements) based on image data.

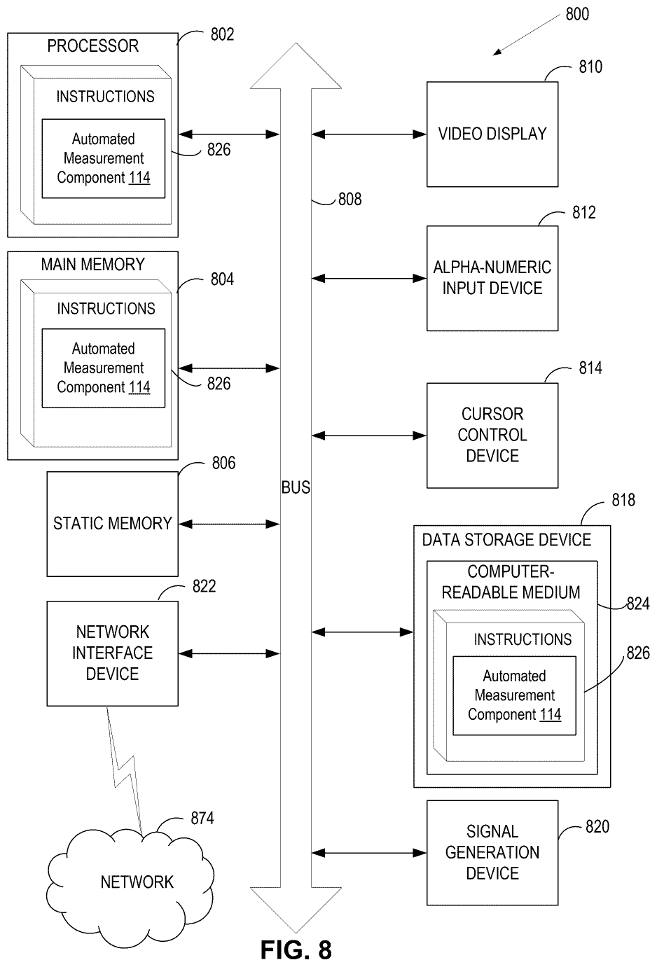

FIG. 8 is a block diagram illustrating a computer system 800, according to certain embodiments. In some embodiments, the computer system 800 is one or more of client device 120, automated measurement system 110, server machine 180, predictive server 112, and/or the like.

In some embodiments, computer system 800 is connected (e.g., via a network, such as a Local Area Network (LAN), an intranet, an extranet, or the Internet) to other computer systems. In some embodiments, computer system 800 operates in the capacity of a server or a client computer in a client-server environment, or as a peer computer in a peer-to-peer or distributed network environment. In some embodiments, computer system 800 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 includes a processing device 802, a volatile memory 804 (e.g., Random Access Memory (RAM)), a non-volatile memory 806 (e.g., Read-Only Memory (ROM) or Electrically-Erasable Programmable ROM (EEPROM)), and a data storage device 818, which communicate with each other via a bus 808.

In some embodiments, processing device 802 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 800 further includes a network interface device 822 (e.g., coupled to network 874). In some embodiments, computer system 800 also includes a video display unit 810 (e.g., a liquid-crystal display (LCD)), an alphanumeric input device 812 (e.g., a keyboard), a cursor control device 814 (e.g., a mouse), and a signal generation device 820.

In some implementations, data storage device 818 includes a non-transitory computer-readable storage medium 824 on which store instructions 826 encoding any one or more of the methods or functions described herein, including instructions encoding components of FIG. 1 (e.g., automated measurement component 114, etc.) and for implementing methods described herein (e.g., one or more of methods 700A-C).

In some embodiments, instructions 826 also reside, completely or partially, within volatile memory 804 and/or within processing device 802 during execution thereof by computer system 800, hence, in some embodiments, volatile memory 804 and processing device 802 also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as application-specific integrated circuits (ASICS), FPGAS, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “training,” “labeling,” “providing,” “receiving,” “applying,” “computing,” “updating,” “extracting,” “adjusting,” “calculating,” “identifying,” “determining,” “causing,” “performing,” “obtaining,” “accessing,” “adding,” “using,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A non-transitory computer-readable storage medium storing instructions which, when executed, cause a processing device to perform operations comprising:
receiving an input comprising a template image and a test image, wherein the template image comprises labels for a first location and a second location associated with a first measurement of the template image;
providing the template image and the test image as input to a trained machine learning model, wherein the trained machine learning model outputs a deformation field based on non-rigid registration of the template image to the test image; and
determining, based on application of the deformation field to the template image, a third location and a fourth location on the test image that correspond to the first location and the second location, respectively, on the template image, wherein the third location and the fourth location are usable to determine the first measurement of the test image.

2. The non-transitory computer-readable storage medium of claim 1, the operations further comprising:
extracting a template signal along a first line intersecting the first location and the second location on the template image;
extracting a test signal along a second line intersecting the third location and the fourth location on the test image; and
adjusting at least one of the third location or the fourth location using a dynamic time warping (DTW) transformation of the test signal to the template signal.

3. The non-transitory computer-readable storage medium of claim 2, wherein the template signal and the test signal each comprise an average of pixel values of pixels along the first line and the second line, respectively.

4. The non-transitory computer-readable storage medium of claim 2, the operations further comprising:
identifying a template signal local maximum, wherein the template signal local maximum is a closest local maximum to a point on the template signal corresponding to the first location on the template image;
identifying a template signal local minimum, wherein the template signal local minimum is a closest local minimum to a point on the template signal corresponding to the first location on the template image;
identifying a test signal local maximum, wherein the test signal local maximum is a closest local maximum to a point on the test signal corresponding to the third location on the test image;
identifying a test signal local minimum, wherein the test signal local minimum is a closest local minimum to a point on the test signal corresponding to the third location on the test image;
calculating a first ratio representing a relationship between a proximity of the point on the template signal to the template signal maximum and a proximity of the point on the template signal to the template signal minimum; and
adjusting the third location so that a second ratio representing a relationship between a proximity of the point on the test signal to the test signal maximum and a proximity of the point on the test signal to the test signal minimum is approximately equal to the first ratio.

5. The non-transitory computer-readable storage medium of claim 1, wherein the third location of the test image corresponds to the first location of the template image after non-rigid registration of the test image to the template image.

6. The non-transitory computer-readable storage medium of claim 2, wherein the first location and the second location of the template image are positioned at a vertical distance from a first reference point, and the third location and the fourth location of the test image are positioned at the vertical distance from a second reference point.

7. The non-transitory computer-readable storage medium of claim 1, wherein the machine learning model comprises at least one of a convolutional neural network (CNN) or an encoder-decoder network.

8. A system comprising:
a memory; and
a processing device coupled to the memory, the processing device to:
receive an input comprising a template image and a test image, wherein the template image comprises labels for a first location and a second location associated with a first measurement of the template image;
provide the template image and the test image as input to a trained machine learning model, wherein the trained machine learning model outputs a deformation field based on non-rigid registration of the template image to the test image; and
determine, based on application of the deformation field to the template image, a third location and a fourth location on the test image that correspond to the first location and the second location, respectively, on the template image, wherein the third location and the fourth location are usable to determine the first measurement of the test image.

9. The system of claim 8, the processing device further to:
extract a template signal along a first line intersecting the first location and the second location on the template image;
extract a test signal along a second line intersecting the third location and the fourth location on the test image; and
adjust at least one of the third location or the fourth location using a dynamic time warping (DTW) transformation of the test signal to the template signal.

10. The system of claim 9, wherein the template signal and the test signal each comprise an average of pixel values of pixels along the first line and the second line, respectively.

11. The system of claim 9, the processing device further to:
identify a template signal local maximum, wherein the template signal local maximum is a closest local maximum to a point on the template signal corresponding to the first location on the template image;
identify a template signal local minimum, wherein the template signal local minimum is a closest local minimum to a point on the template signal corresponding to the first location on the template image;
identify a test signal local maximum, wherein the test signal local maximum is a closest local maximum to a point on the test signal corresponding to the third location on the test image;
identify a test signal local minimum, wherein the test signal local minimum is a closest local minimum to a point on the test signal corresponding to the third location on the test image;
calculate a first ratio representing a relationship between a proximity of the point on the template signal to the template signal maximum and a proximity of the point on the template signal to the template signal minimum; and
adjust the third location so that a second ratio representing a relationship between a proximity of the point on the test signal to the test signal maximum and a proximity of the point on the test signal to the test signal minimum is approximately equal to the first ratio.

12. The system of claim 8, wherein the third location of the test image corresponds to the first location of the template image after non-rigid registration of the test image to the template image.

13. The system of claim 9, wherein the first location and the second location of the template image are positioned at a vertical distance from a first reference point, and the third location and the fourth location of the test image are positioned at the vertical distance from a second reference point.

14. The system of claim 8, wherein the machine learning model comprises at least one of a convolutional neural network (CNN) or an encoder-decoder network.

15. A method comprising:
processing a source image and a target image of a same type of structure using a machine learning model to generate a deformation field between the source image and the target image;
applying the deformation field to a source mask associated with the source image to create a warped source mask, wherein the source mask comprises labels of one or more regions of the source image;
computing a loss based on a comparison of the warped source mask and the target image; and
training the machine learning model based at least in part on the loss.

16. The method of claim 15, further comprising generating the source mask based on labeling of one or more regions of the source image.

17. The method of claim 15, the training further comprising:
applying the deformation field to the source image to create a warped source image;
computing one or more similarity metrics losses based on a comparison of the target image and the warped source image; and
training the machine learning model based at least in part on the one or more similarity metrics losses.

18. The method of claim 17, wherein the loss based on the comparison of the warped source mask and the target image comprises a structural integrity loss, and wherein the one or more similarity metrics losses based on the comparison of the target image and the warped source image comprise a structural similarity index (SSI) loss and a Pearson correlation coefficient (PCC) loss.

19. The method of claim 15, wherein the machine learning model comprises at least one of a convolutional neural network (CNN) or an encoder-decoder network.

20. The method of claim 15, further comprising:
receiving an input comprising a template image and a test image, wherein the template image comprises labels for a first location and a second location associated with a first measurement of the template image;
providing the template image and the test image as input to the trained machine learning model, wherein the trained machine learning model outputs a deformation field based on non-rigid registration of the template image to the test image; and
determining, based on application of the deformation field to the template image, a third location and a fourth location on the test image that correspond to the first location and the second location, respectively, on the template image, wherein the third location and the fourth location are usable to determine the first measurement of the test image.
